(19) United States
(12) Patent Application Publication
(10) Pub. No.: US 2026/0287512 A1
(43) Pub. Date: Sep. 24, 2026

(54) LUMINESCENCE SIGNAL AMPLIFICATION

(71) Applicant: UNIVERSITY OF WYOMING, Laramie, WY (US)

(72) Inventor: Debashis DUTTA, Laramie, WY (US)

(21) Appl. No.: 19/479,174

(22) PCT Filed: Apr. 26, 2024
(86) PCT No.: PCT/US2024/026427

§ 371 Date: Oct. 27, 2025

Related U.S. Application Data
(60) Provisional application No. 63/462,457, filed on Apr. 27, 2023.

(51) Int. Cl. G01N 21/76

(52) U.S. Cl. CPC G01N 21/76; G01N 2201/0636

(57) ABSTRACT

Embodiments described herein generally relate to luminescent detection devices and systems, and to methods for luminescent detection. In an embodiment is provided a device for luminescence detection. The device includes a first layer comprising an optically-transparent material, the first layer having a first surface and a second surface opposite the first surface. The device further includes a second layer comprising a well, the well comprising: an opening, the opening formed in the second layer and facing the first surface of the first layer; a bottom wall disposed opposite the opening; and a sidewall extending between the opening and the bottom wall. The device further includes a metal layer disposed over at least a portion of the bottom wall and the sidewall of the well.

### GOVERNMENT RIGHTS

The invention was made with government support under Grant No. CHE-1808507 awarded by the National Science Foundation. The government has certain rights in the invention.

### FIELD

Embodiments described herein generally relate to luminescent detection devices and systems, and to methods for luminescent detection. Embodiments described herein also generally relate to methods of detecting an analyte in a sample.

### BACKGROUND

Luminescent detection methods, such as fluorescence detection methods, are widely used in chemical and biological measurements due to their high sensitivity, selectivity and applicability to a broad range of analytes. For fluorescence detection methods, conventional technologies have tried to improve the detection limit by utilizing sensitive detectors, extension of the optical path length, and pre-concentration of analyte or signaling molecules in the detection zone. These approaches, however, rely on developing advanced instrumentation for the detection process or manipulation of analyte transport to spatially focus those molecules in the detection region. Unfortunately, the integration of such capabilities generally renders the analytical platform more expensive and/or difficult to operate restricting their access by the broad research community. Conventional pre-concentration devices either require the user to have substantial expertise in instrumental methods or be willing to purchase specialized platforms to operate them. As a result, there is a growing emphasis on developing analytical systems that are easily accessed by researchers from various disciplines so as to improve the impact of these innovations on scientific work.

There is a need for new devices, systems, and methods for luminescent detection.

### SUMMARY

Embodiments described herein generally relate to luminescent detection devices and methods for luminescent detection. Embodiments described herein may be utilized for detecting the presence or the absence of an analyte in a sample. Embodiments of the present disclosure include a novel approach to amplifying a luminescent signal in circular assay wells by focusing the incident and emitted radiation using reflective surfaces. This signal enhancement is enabled by a plurality of factors: First, the analyte molecules were subjected to more incident radiation due to optical reflection by the metal layer which in turn increased their luminescent emission. Second, the metal surfaces reflected back a larger fraction of the emitted light towards the detector that otherwise would not have been recorded. Third, the curvature of the metal surface of the assay wells focuses at least some of the reflected incident and emitted light in distinct regions creating signal hotspots. In combination, embodiments described herein provide a 20-fold enhancement, or 30-fold enhancement, or more signal amplification in luminescence intensity for luminescence detection that may be realized upon quantitating the signal around the center of metal-coated circular assay wells. The enhancement factor may be further improved by controlling the curvature of the assay well surface to merge all the signal hotspots within a smaller detection zone.

In an embodiment is provided a device for luminescence detection. The device includes a first layer comprising an optically-transparent material, the first layer having a first surface and a second surface opposite the first surface. The device further includes a second layer comprising: a well comprising: an opening, the opening formed in the second layer and facing the first surface of the first layer; a bottom wall disposed opposite the opening; and a sidewall extending between the opening and the bottom wall, the sidewall having a first region extending from the opening and a second region extending from the first region to the bottom wall, the first region having a substantially constant or constant radius and the second region having a first radius adjacent to the first region and a second radius adjacent to the bottom wall, wherein the second radius is smaller than the first radius. The device further includes an optically reflective metal layer disposed over at least a portion of the bottom wall and the sidewall of the well.

In another embodiment is provided a luminescence detection system. The luminescence detection system includes a device for luminescence detection described herein, and a detector adapted to be optically coupled to the device for luminescence detection.

In another embodiment is provided a method of detecting an analyte in a sample. The method includes introducing a sample to a well of a device for luminescence detection described herein under conditions effective to detect an analyte present in the sample. The method further includes detecting the presence or absence of the analyte in the well with a detector.

### BRIEF DESCRIPTION OF THE DRAWINGS

So that the manner in which the above recited features of the present disclosure may be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A is a schematic diagram showing a cross-sectional view of a nanowell of a device according to at least one embodiment of the present disclosure.

FIG. 1B is a schematic diagram showing a top view of a nanowell of a device according to at least one embodiment of the present disclosure.

FIG. 1C is a schematic diagram showing a cross-sectional view of the second layer and nanowell according to at least one embodiment of the present disclosure.

FIGS. 1D and 1E show a schematic diagram of glass substrates (first and second layers) with the supporting channel and the nanowell according to at least one embodiment of the present disclosure.

FIG. 1F is a schematic diagram of a bonded microchip (a bonded first layer and second layer) according to at least one embodiment of the present disclosure.

FIG. 1G is an optical image of 300-μm-diameter, 30-μm-deep nanowells with and without an aluminum layer according to at least one embodiment of the present disclosure.

FIG. 1H is an optical image of an example glass microchip.

FIG. 1I is an optical image of an example microwell array.

FIG. 2 shows a schematic of microchip fabrication using photolithography assisted by wet etching for channel engraving on the substrate (left panel) and a fabricated microchip utilized for preliminary investigations (right panel) according to at least one embodiment of the present disclosure.

FIGS. 3A and 3B shows two plates utilized to form a microchip.

FIG. 3C shows a fabricated microchip formed from the two plates shown in FIGS. 3A and 3B.

FIG. 4 shows a fabricated microchip (left panel) with a circular well ranging from about 38 μm to about 1.2 mm in diameter, with the magnified images (right panel) showing the three-dimensional (3D) structure of the well with dimensions.

FIG. 5 shows experimental data obtained using a microchip (shown in FIG. 1I) having a channel of 1 mm in width and 30 μm in depth.

FIG. 6 shows experimental data for the effect of channel depth on sensitivity of fluorescein dye.

FIGS. 7A and 7B show fluorescence images/profiles of a 150-μm-diameter, 30-μm-deep nanowell with a metal coating and without a metal coating (FIG. 7B), respectively, each containing 1.92 μM of fluorescein dye. Histograms of the pixels in various areas of the nanowells are also shown.

FIG. 7C shows fluorescence images for the nanowells shown in FIGS. 7A and 7B containing various concentrations of the fluorescein dye.

FIG. 7D shows the corresponding intensity data from the fluorescence images of FIG. 7C. The standard deviations are based on five independent measurements.

FIG. 7E shows an image of a metal-coated well and data for signal amplification at various places of the metal-coated well, indicating about 30× improvement in sensitivity. The data shown in the bar graph was plotted using histogram peak pixel at different places of the metal-coated well.

FIG. 8A shows fluorescence images for a 200 μm×150 μm rectangular nanowell with and without a metal layer containing various concentrations of the fluorescein dye.

FIG. 8B shows the corresponding intensity data from the fluorescence images of FIG. 8A. The standard deviations are based on five independent measurements.

FIG. 9A shows fluorescence images of circular nanowells of varying diameters with and without a metal layer.

FIG. 9B shows fluorescence readings from the images shown in FIG. 9A (left y-axis) and the corresponding signal enhancement factor for the same metal-coated circular nanowell (right y-axis). This enhancement factor was calculated based on the slope of the regression lines fitted to the data obtained by imaging fluorescein samples of varying concentrations. The standard deviations are based on five independent measurements.

FIG. 10A shows fluorescence images of circular nanowells of varying depths with and without a metal layer containing about 0.67 μM of the fluorescein sample. All nanowells in these images were fabricated by transferring a 38-μm-diameter circular pattern onto the top plate.

FIG. 10B shows a fluorescence profile in the same circular nanowells of FIG. 10A recorded along a straight line running through their central and peripheral hotspots.

FIG. 10C shows the signal enhancement factor for the same metal-coated circular nanowells estimated from the fluorescence intensity recorded at their central hotspots. This enhancement factor was calculated based on the slope of the regression line fitted to the data obtained by imaging fluorescein samples of varying concentrations. The standard deviations are based on five independent measurements.

FIG. 10D shows depth profiles of the different Al-coated wells shown in FIG. 10A.

FIGS. 11A and 11B show the observed variation in the fluorescence intensity with enzyme reaction time in circular nanowells (FIG. 11A) without and (FIG. 11B) with the metal layer for various horseradish peroxidase (HRP) concentrations. All nanowells in these images were fabricated by transferring a 38-μm-diameter circular pattern onto the top plate, and the data included in (FIG. 11B) was obtained by analyzing the central hotspot in the metal-coated nanowells.

FIG. 11C shows the variation in the slope of the regression lines fitted to the data included in FIGS. 11A and 11B with HRP concentration. The standard deviations included are based on five independent measurements.

FIG. 11D shows a fluorescence image of the metal-coated nanowell containing about 16.8 ng/mL HRP sample after about 26 minutes of enzyme reaction.

FIG. 12A shows an optical image of micromilled sample wells on a polycarbonate plate (top panel) and an optical image of the micromilled sample wells' centers aligned with those of the microwells in a commercial available microwell plate (bottom panel).

FIG. 12B is a schematic cross-section of the micromilled samples wells on the polycarbonate plate shown in the top panel of FIG. 12A.

FIG. 12C is a plot showing the improvement in fluorescence detection using metal coated micromilled sample wells.

FIG. 13A shows an optical image of micromilled sample wells' centers aligned with those of the microwells in a commercial available microwell plate (left panel), a three-dimensional (3D) printed uncoated polylactic acid (PLA) plate (middle panel), and a 3D-printed aluminum coated PLA plate (right panel).

FIG. 13B is a schematic cross-section of the 3D printed sample wells on the PLA plate.

FIG. 13C is a plot showing the improvement in fluorescence detection using metal-coated 3D printed sample wells.

FIG. 14A is a schematic that shows focusing of incident light by a convex sample meniscus.

FIG. 14B is a plot showing the improvement in fluorescence detection exploiting the convex sample meniscus measured using 3D printed sample wells.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to luminescent detection apparatus and methods for luminescent detection. Embodiments described herein also generally relate to methods of detecting the presence or absence of an analyte in a sample.

Many different analyte detection devices and systems exist. However, those that are practically applied in a research, clinical, point of care, or other setting requiring accuracy and reliability are fairly limited and tend to be complex and expensive. For example, highly sensitive analytical techniques are required to quantify lower abundant disease biomarkers such as antigens (analytes) in bodily fluids. Miniaturization of assays in the form of, for example, microfluidic and nanofluidic systems, often allows improvements in assay result alongside time and cost savings. A significant drawback in reducing the size of the assay platform is the decreased sensitivity for the analyte of interest. For example, due to the optical path lengths of micrometer and sub-micrometer scales, absorbance and fluorescence detection methods cannot be reliably used. In addition, micro- and nanofluidic devices are frequently incompatible with commercial instruments, such as microplate readers, making their automation difficult by scientists. Further, methods of detecting analytes are restricted by the limit of detection. The limit of detection (LOD; or detection limit) is the lowest signal, or the smallest corresponding quantity of an analyte to be determined from the signal, that is reliably detected.

Several state-of-the-art strategies to improve the detection limit of microfluidic devices exist and include pre-concentration of the analyte or signaling molecules in the detection zone, increasing sample volume, extending the optical path length, manipulating the electric field, isoelectric focusing, and utilizing sensitive and advanced detectors. These state-of-the-art methods are limited by the availability of the sample of interest and expertise required to operate devices, rendering such conventional techniques unsuitable for practical purposes and hinders such methods from being a benchtop technology. For example, pre-concentration techniques which involve trapping or capturing of analyte molecules onto a target surface, are difficult to integrate with microchip operations. Sensitive and advanced detectors are useful but are too expensive. With respect to fluorescence detection, conventional strategies for signal amplification involve enzymatic signal multiplication or replication of the targeted analyte.

In contrast to these conventional technologies, the inventor has discovered apparatus having a unique geometry and a reflective surface enabling amplification of a signal. Generally, the apparatus includes a first layer comprising an optically transparent material and a second layer comprising one or more wells. Each of the one or more wells includes an opening that faces a first surface of the first layer, a bottom wall, and a sidewall extending between the opening and the bottom wall. The apparatus further includes a metal layer disposed over at least a portion of the bottom wall and the sidewall of the one or more layers. The metal layer reflects escaping excitation light, allowing the light to strike the targeted analyte multiple times. Relative to conventional technologies, apparatus described herein enables the interaction of light and matter in a more efficient manner and results in a higher emitted signal.

The use of headings is for purposes of convenience only and does not limit the scope of the present disclosure. Embodiments described herein may be combined with other embodiments.

Embodiments of the present disclosure generally relate to devices (or articles) used for detecting and/or characterizing an analyte present in a sample. The devices may be utilized for luminescence detection. The devices may be in the form of a microchip or a microfluidic device.

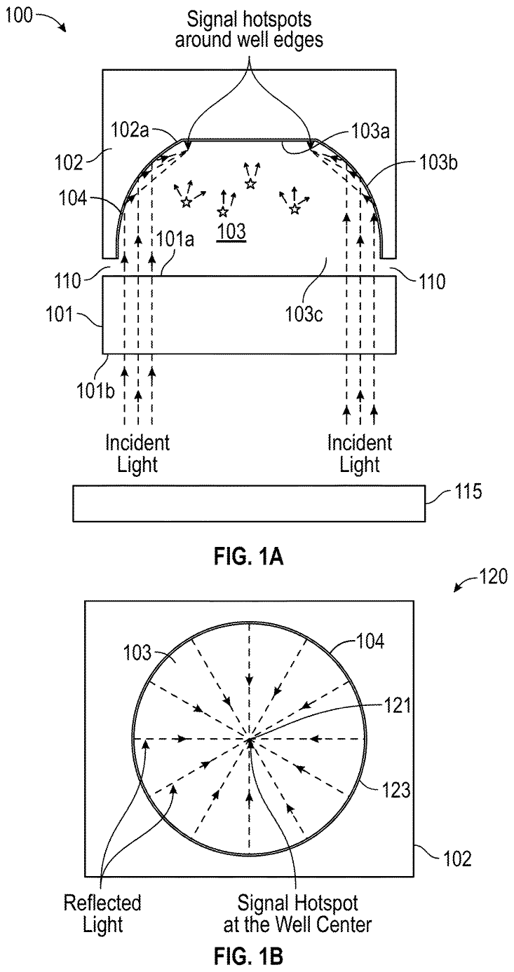

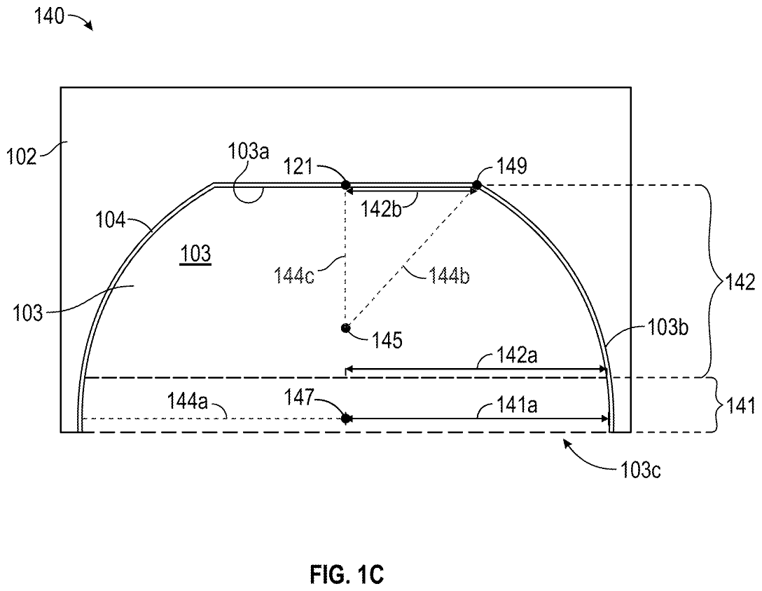

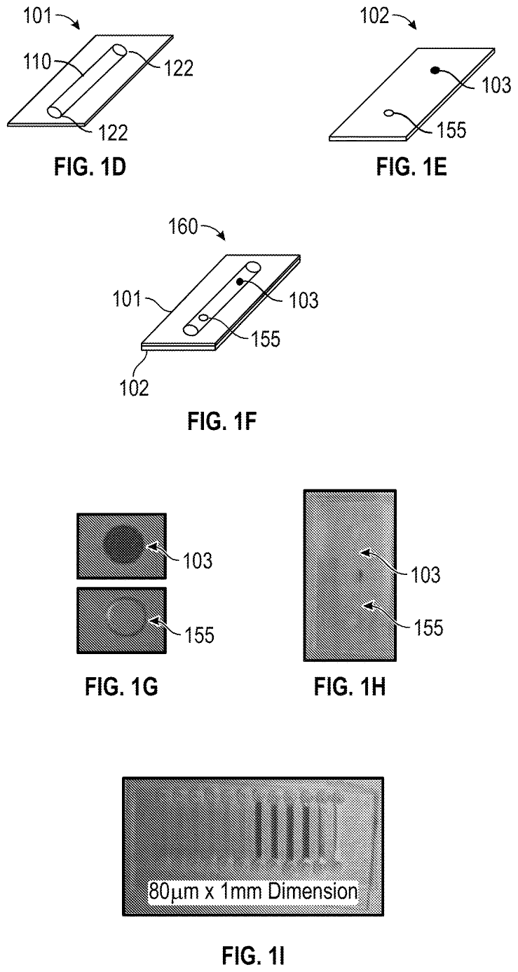

An example of the device 100 is shown in FIGS. 1A-1I. FIG. 1A is a cross-sectional view of a well 103 of the device, FIG. 1B is a top view of the well 103 of the device 100. FIGS. 1D and 1E are schematic views of a first layer 101 of the device 100 and a second layer 102 of the device 100, respectively. FIG. 1F shows the device as a bonded microchip 160 that includes the first layer (FIG. 1D) and the second layer (FIG. 1E). Optical images of the wells 103, the bonded microchip 160, and a microwell array 180 are shown in FIGS. 1G-1I. FIGS. 1D-1I show an additional well without a metal coating. This uncoated well is utilized for experiments as a comparative and is only optional in the device 100.

As shown in FIG. 1A, the device 100 includes a first layer 101 (bottom plate) having a first surface 101a and a second surface 101b opposite the first surface. The device 100 further includes a second layer 102 (top plate, shown in FIG. 1D). A well 103, or a plurality of wells (also called nanowells), is formed in the second layer 102. Although the well 103 may be described as “nanowells”, the well 103 may be of larger or smaller sizes such as microwells, macrowells, picowells, etc.

The well 103 includes an opening 103c formed in the second layer 102 and facing the first surface 101a of the first layer 101. The well 103 further includes a bottom wall 103a disposed opposite the opening 103c. The well 103 further includes a sidewall 103b extending between the opening 103c of the well 103 and the bottom wall 103a of the well 103. Further features of the well are described below with respect to FIG. 1C. Although the well 103 of FIG. 1A is shown as having a substantially flat or flat (planar) bottom wall 103a, the bottom wall 103a may be rounded, curved, or concave. A sample for detection or characterization may be disposed in the well 103. As shown, the sample may include analyte molecules (shown in FIG. 1A as stars).

The first layer 101 may be made of or include a material having certain properties such as optically-transparent, substantially optically-transparent, selectively optically transparent, or combinations thereof. As used herein, optically-transparent material refers to photons transmitting through the material. For example, the material of the first layer 101 may be optically-transmissive such that photons pass through the material instead of being absorbed or reflected by the material. The material of the first layer 101 may be substantially optically-transmissive, for example, such that about 75% or more of light passes through the material, such as about 80% or more, about 90% or more, about 95% or more, about 99% or more, or about 100%. That is, the material of the first layer 101 is sufficiently transparent to permit radiation to pass through the first layer 101 and into the well 103 where a sample is disposed. The first layer 101 may be characterized as having low autofluorescence. The first layer 101 may be selected based on refractive index (such as a low reflective index), absorptive properties (such as low absorption), or combinations thereof. The first layer 101 may be selectively transparent and/or selectively absorptive.

In some embodiments, the first layer 101 may be made from, or include, glass, borosilicate, SiO₂, a polymer, or combinations thereof, among others. Illustrative, but non-limiting, examples of polymers may include polycarbonate, polyethylene terephthalate (PET), polyethylene terepthalate glycol (PETG), polyethylene naphthalate, polyacrylate, polymethylmethacrylate, polyimide, polyolefin (e.g., polyethylene such as low density polyethylene and high density polyethylene), cyclic olefin copolymers, among others.

The second layer 102 may be made of, or include, the same or similar material as the first layer 101.

As shown in FIG. 1A, a metal layer 104 (or coating or film) is disposed over a surface of the second layer, such as a surface of the well, e.g., over at least a portion of the bottom wall 103a and over at least a portion of the sidewall 103b of the well 103. The metal layer 104 may be in the form of a coating or film disposed on a first surface 102a of the second layer 102. The metal layer 104 may be deposited on the well 103 by, e.g., vapor deposition. Additionally, or alternatively, the metal layer 104 may be coupled to the well 103 by an adhesive.

The metal layer 104 may be optically reflective. The metal layer 104 may be made of, or include, any suitable metal such as aluminum (Al), gold (Au), silver (Ag), nickel (Ni), copper (Cu), brass, steel, alloys, or combinations thereof.

The metal layer 104 may be conformal and uniform to the surface of the well 103. The surface of the well includes the bottom wall 103a and the sidewall 103b. The metal layer 104 may have any suitable thickness. In some embodiments, a thickness of the metal layer 104 may be about 10 nm or more, about 1,000 nm or less, or combinations thereof, such as from about 25 nm to about 500 nm, such as from about 50 nm to about 200 nm, such as from about 75 nm to about 150 nm, from about 75 nm to about 125 nm, from about 90 nm to about 125 nm, from about 100 nm to about 110 nm, or from about 95 nm to about 105 nm, or from about 50 nm to about 150 nm, though other values are contemplated. Any of the foregoing numbers may be used singly to describe an open-ended range or in combination to describe a close-ended range. The thickness of the metal layer 104 may be non-uniform over the surface of the well 103. The metal layer 104 may be textured. Such texturing may aid in increasing light reflection which amplifies the signal detected.

Additionally, or alternatively, the metal layer 104 can instead be made of any suitable reflective material. For example, the reflective material that may be used in place of metal layer 104 can be made from polymers (e.g., polylactic acid) that have additives therein which make the surfaces reflective.

The well 103 may have any suitable shape. Excluding the depth dimension, and in some embodiments, the opening 103c of the well 103 may be circular, square, rectangular, triangular, or other polygonal shape. The shape of the well 103 may be cylindrical, conical, frustoconical, or may be multi-sided so as to approximate a cylindrical, conical, or frustoconical shape. The well 103 may have a smooth wall surface or may have at least one irregular wall surface. The bottom wall 103a of the well 103 may be concave, convex, or planar.

The well 103 may have any suitable dimensions. The opening 103c of the well 103 may have a diameter (or width) in one dimension that is about 1 micron (μm) or more, about 1,000 μm or less, or combinations thereof, such as about 800 μm or less, such as about 600 μm or less, such as about 300 μm or less, such as about 250 μm or less, such as from about 1 μm to about 200 μm, such as from about 5 μm to about 150 μm, such as from about 10 μm to about 100 μm, such as from about 15 μm to about 80 μm, such as from about 20 μm to about 60, such as from about 25 μm to about 50 μm, such as from about 30 μm to about 40 μm, such as from about 35 μm to about 40 μm, such as about 38 μm or about 30 μm, though other values are contemplated. Any of the foregoing numbers may be used singly to describe an open-ended range or in combination to describe a close-ended range.

Alternatively, the opening 103c of the well 103 may have a diameter (or width) in one dimension that is about 8 millimeters (mm) (about 8,000 μm) or less, such as from about 10 μm to about 5,000 μm, such as from about 20 μm to about 1 μm, such as from about 50 μm to about 800 μm, such as from about 100 μm to about 600 μm, such as from about 160 μm to about 440 μm, such as from about 200 μm to about 400 μm, such as from about 250 μm to about 350 μm, such as from about 275 μm to about 325 μm. Any of the foregoing numbers may be used singly to describe an open-ended range or in combination to describe a close-ended range.

In some embodiments, the diameter (or width) of the opening 103c of the well 103 may be matched with the diameter of a light beam that radiates from detector 115.

The bottom wall 103a of the well 103 may have a diameter (or width) in one dimension that is the same as, or different than, that of the opening 103c. In some embodiments, the bottom wall 103a of the well 103 has a diameter (or width) in one dimension that is about 0.95× the diameter (or width) of the opening 103c or less, such as about 0.9× or less, such as about 0.85× or less, such as about 0.8× or less, such as about 0.75× or less, such as about 0.7× or less, such as about 0.65× or less, such as about 0.6× or less, such as about 0.55× or less, such as about 0.5× or less, such as about 0.45× or less, such as about 0.4× or less, such as about 0.35× or less, such as about 0.3× or less, such as about 0.25× or less, such as about 0.2× or less, such as about 0.15× or less, such as about 0.1× or less, such as about 0.05× or less, though other values are contemplated. Any of the foregoing numbers may be used singly to describe an open-ended range or in combination to describe a close-ended range.

In some embodiments, at least a portion of the sidewall 103b may be perpendicular to the opening 103c and the bottom wall 103a. In at least one embodiment, at least a portion of the sidewall 103b may be curved or sloped relative to the opening 103c and/or the bottom wall 103a as shown in FIG. 1A.

The well 103 may have any suitable depth. The depth of the well 103 is measured from the opening 103c surface to the bottom wall 103a. The well 103 may have a depth that is about 1 μm or more, about 200 μm or less, or combinations thereof, such as about 100 μm or less, from about 1 μm to about 100 μm, such as from about 5 μm to about 60 μm, such as from about 10 μm to about 50, such as from about 15 μm to about 40 μm, such as from about 20 μm to about 35 μm, such as from about 25 μm to about 30 μm or from about 30 μm to about 35 μm, or from about 15 μm to about 45 μm, though other values are contemplated. Any of the foregoing numbers may be used singly to describe an open-ended range or in combination to describe a close-ended range.

Alternatively, the depth of the well 103 may be about 4 mm (about 4,000 μm) or less, such as from about 5 μm to about 2,000 μm, such as from about 15 μm to about 1,000 μm, such as from about 40 μm to about 600 μm, such as from about 60 μm to about 400 μm, such as from about 80 μm to about 220 μm, such as from about 100 μm to about 200 μm, such as from about 120 μm to about 180 μm, such as from about 140 μm to about 160 μm. Any of the foregoing numbers may be used singly to describe an open-ended range or in combination to describe a close-ended range.

The size of the well 103 may be made to accommodate any suitable volume. The volume of the well 103 is defined by the diameter (or width) in one dimension of the opening 103c, the diameter (or width) in one dimension of the bottom wall 103a, and the depth measured from an opening surface to the bottom wall 103a. A diameter (or width) and depth less than 1 mm will produce wells with volumes smaller than 1 μL. For example, the well 103 may have a volume of about 100 nanoliters (nL) or more, about 100,000 nL (100 μL) or less, or combinations thereof, such as from about 500 nL (0.5 μL) to about 100,000 nL (100 μL), such as from about 1,000 nL (1 μL) to about 50,000 nL (50 μL), such as from about 5,000 nL (5 μL) to about 30,000 nL (30 μL), such as from about 8,000 nL (8 μL) to about 15,000 nL (15 μL), such as about 9 μL, about 10 μL, about 11 μL, about 12 μL, about 13 μL, or about 14 μL, or from about 1 μL to about 30 μL, such as from about 5 μL to about 25 μL, such as 10 μL to about 20 μL, or from about 1 μL to about 22 μL, though other values are contemplated. Any of the foregoing numbers may be used singly to describe an open-ended range or in combination to describe a close-ended range.

Volumes for wells may be 1 μL or less. For a well 103 having a volume that is from less than 1 μL, the diameter of the opening 103c of the well 103 may be about 1000 μm or less and the depth of the well 103 from the opening 103c to the bottom wall 103a of the well 103 may be about 1000 μm or less.

In an example of a well 103 having a volume of about 0.001 μL to about 0.01 μL, the diameter of the opening 103c of the well 103 may be about 300 μm or less and the depth of the well 103 from the opening 103c to the bottom wall 103a of the well 103 may be about 100 μm or less.

In an example of a well 103 having a volume of about 0.004 nL to about 0.012 nL, the diameter of the opening 103c of the well 103 may be from about 20 μm to about 60 μm and the depth of the well 103 from the opening 103c to the bottom wall 103a of the well 103 may be from about 15 μm to about 45 μm.

Although the device 100 is described as having one well 103 that is coated with a metal layer 104, the device may include a plurality of wells 103, wherein each well of the plurality of wells may be, independently, coated with metal layer 104 or uncoated. The plurality of wells may be in the form of an array of wells, such as 96 wells, 144 wells, 1,000 wells, or other suitable numbers of wells depending on, e.g., the end use of the device such as the number of assays or number of individual assays. In some embodiments, one or more wells of the plurality of wells may be isolated, such as all of the wells may be isolated. The wells may be isolated such that a liquid does not pass between wells. Additionally, or alternatively, the wells may be optically isolated such that light or radiation is not substantially transmitted between wells.

FIG. 1C is a schematic diagram showing a cross-sectional view 140 of the second layer 102 and well 103 shown in FIG. 1A according to at least one embodiment of the present disclosure.

As shown, the sidewall 103b has a first region 141 extending from the opening 103c and a second region 142 extending from the first region 141 to the bottom wall 103a. The first region 141 has, or is defined by, a substantially constant or constant radius 141a. When the first region 141 is defined by a substantially constant or constant radius 141a, the first region is cylindrical in shape. Alternatively, the first region 141 may be angled inward relative to the opening 103c. For example, the radius of the first region 141 may decrease by less than about 10%, such as less than 5% from the opening 103c to a first radius 142a of the second region 142. In this latter embodiment, the sidewall 103b is angled to an incoming light beam so that light rays may be reflected toward a center of the well 103.

The sidewall 103b also has a second region 142 extending from the first region 141 to the bottom wall 103a. The second region 142 has, or is defined by, a first radius 142a adjacent to the first region 141 and a second radius 142b adjacent to the bottom wall 103a. The second radius 142b is smaller than the first radius 142a.

The radius of the second region 142 may decrease at a substantially uniform rate or uniform rate from the first radius 142a of the second region 142 to the second radius 142b of the second region 142. In such embodiments, the well 103 has a substantially conical or conical shape.

Alternatively, the radius of the second region 142 may decrease at a substantially non-uniform rate or non-uniform rate from the first radius 142a of the second region 142 to the second radius 142b of the second region 142. In such embodiments, the well 103 has a curved or hemispherical shape.

Wells 103 described herein may include a single focal point. The single focal point may be located in the second region 142. The single focal point may be positioned along a vertical axis 144c of the well 103 and between the center 121 of the bottom wall 103a and the volumetric center 145 of the well 103.

Additionally, or alternatively, wells 103 described herein may include a plurality of focal points (two or more) that are not significantly separated in the vertical direction. In such embodiments, the plurality of focal points may be positioned along the vertical axis 144c of the well 103 and between the center 121 of the bottom wall 103a and the volumetric center 145 of the well 103. Because the signal collected by the detector 115 is an integral of the light intensity along the vertical axis 144c of the well 103, the existence of the plurality of focal points does not substantially compromise the detection sensitivity of the platform.

A single focal point or a plurality focal points that are not significantly separated enables the increased detection sensitivity of embodiments described herein. Here, and during detection, the detector 115 is focused onto the single focal point or the plurality of focal points that are not significantly separated.

The second region 142 may have one or more focal points (a single focal point or a plurality of focal points) positioned along the vertical axis 144c of the well 103 and between the center 121 of the bottom wall 103a and the volumetric center 145 of the well 103. The focal point is the point at which, for example, light rays meet after reflection of the light off of the metal layer 104, thus increasing the signal for detection.

Similarly, the first region 141 may have one or more focal points positioned along the vertical axis 144c of the well 103 and between the center 121 of the bottom wall 103a and the volumetric center 145 of the well 103.

The well 103 may further include a first radius of curvature 144a in the horizontal direction (out of the plane of the paper). The first radius of curvature 144a is shown in FIG. 1C as extending from a center 147 of the well to the sidewall 103b. The well 103 may further include a second radius of curvature 144b in the vertical direction (in the plane of the paper). The second radius of curvature 144b is shown in FIG. 1C as extending from a volumetric center 145 of the well 103 to a point 149 along the bottom wall 103a.

The second radius of curvature 144b is perpendicular to the first radius of curvature 144a. The first and second radius of curvature (horizontal and vertical directions) further aid in spatially focusing at least some of the reflected incident and emitted radiation in distinct regions of the well 103. For example, and as shown in FIG. 1B, reflected incident and emitted radiation may become focused at the well center 121 (along the bottom wall 103a), creating a signal hotspot. Radiation may also become focused along an edge 123 (or circumference) or circumference of the well 103 creating one or more signal hotspots along the edge 123 of the well 103.

As shown in FIG. 1A and FIG. 1B, the analyte molecules (e.g., fluorophores, shown as stars in FIG. 1A) in the well 103 are subjected to more radiation due to the optical reflection of the incident light by the metal layer 104 (see FIG. 1A). The reflection leads to a higher fluorescence signal as the light emitted by a fluorophore increases with the amount of incident radiation it is exposed to. The metal layer 104 also reflects back some of the radiation emitted by the fluorophores towards the detector 115 that otherwise would not have been recorded, e.g., the fluorescent light emitted in the direction opposite to where the detector is located in FIG. 1A. The curvature of the surface of the metal layer 104 in the horizontal and vertical cross sections spatially focuses at least some of the reflected incident and emitted radiation in distinct regions of the well 103. For example, and as shown in FIG. 1B, reflected incident and emitted radiation may become focused at the well center 121 (along the bottom wall 103a), creating a signal hotspot. Radiation may also become focused along an edge 123 (or circumference) or circumference of the well 103 creating one or more signal hotspots along the edge 123 of the well 103.

As stated above, FIGS. 1D-1I show an additional well without a metal coating. This uncoated well 155 is utilized for experiments as a comparative and is only optional in the device 100. Further, an optional channel 110 (also referred to as supporting channel) may be formed on the first layer 101 (bottom plate). The optional channel 110 may be utilized to introduce sample via access holes 122 drilled into the first layer 101. In these and other embodiments, at least a portion of the optional channel 110 may be positioned between a first well (e.g., well 103 which is metal coated) and a second well (e.g., uncoated well 155). The optional channel 110 may be in fluid communication with the first well (e.g., well 103) and the uncoated well 155.

Devices described herein enable improvements in the luminescent signal intensity to achieve improved luminescent detection relative to conventional technologies. The enhanced signal may be due to various parameters of the device such as the reflective metal layer, the depth of the well, the diameter of the well, the shape of the well, surface curvature of the well, a radius of curvature of the well (shown in FIG. 1A), or combinations thereof, among other parameters.

The device may be made by various methods. For example, a photoresist may be positioned on a surface of the second layer 102 (top plate), and a mask positioned on the photoresist. The mask may be utilized to pattern the well(s) 103 of desired dimensions using photolithography. A photoresist and mask may be utilized to pattern the optional channel 110 (supporting channel) onto the first layer 101 (bottom plate) using photolithography. Embodiments of the photolithography are further described in the Examples. Access holes 122 may be drilled at the terminals of the optional channel 110 on the first layer 101. The metal layer 104 (or film or coating) may be deposited on a surface of the second layer 102 using vapor deposition and/or an evaporator. Photoresist may be removed by standard techniques. The device may then be sealed off by bringing the first and second layers into contact and allowing the first and second layers to bond.

Embodiments of the present disclosure also generally relate to luminescent detection systems. The luminescent detection system may be utilized for detecting the presence and/or quantity of an analyte residing in a test sample, and/or characterizing the analyte present in a test sample.

The luminescent detection system may include a device described herein (which may be in the form of, for example, a microchip or microfluidic device) and a detector 115. The detector is adapted to be optically coupled to the device. As shown in FIG. 1A, the detector is positioned below the first surface 101a of the first layer 101, nearer to the nearer to the second surface 101b of the first layer 101. The detector 115 may be a luminescent detector, detecting a fluorescent signal, a phosphorescent signal, a chemiluminescent signal, an electrochemiluminescent signal, or combinations thereof, among others. The detector 115 may include a fluorescence detector, a phosphorescent detector, a chemiluminescence detector, electrochemiluminescence detector, or combinations thereof, among others.

In some embodiments, the detection, such as fluorescence detection, may be performed using a CCD camera or a confocal microscope among other detection methods.

The disclosed devices and systems may be used in an assay to detect an analyte. The assay may include the detection of a luminescent signal emanating from the well of the device and/or the analyte.

Embodiments of the present disclosure also relate to detection methods using devices and/or systems described herein. In an embodiment is provided a method of detecting the presence or absence of an analyte (shown as stars in FIG. 1A) in a sample. The method may include introducing a sample to a well 103 and detecting the presence or absence or absence of the analyte in the well 103 with detector 115. Optionally, the method may include adding any suitable reagent or additive that would aid in detecting the presence or absence of an analyte. For example, a reagent may be added that when reacted with the analyte or other component in the well forms a molecule that is detectable by light-based methods such as fluorescence techniques or other suitable techniques. When the analyte is absent, a different signal (or no signal at all) is detected. The detecting the presence or absence of an analyte may include detecting light that is indicative of the presence of the analyte. The detecting light that is indicative of the presence of the analyte may include detecting light by absorbance, reflectance, or fluorescence, or combinations thereof.

Many enzymatic assays utilize fluorescence. In some examples, the introducing the sample may include introducing an enzyme and a substrate to the well of the device. Reaction of the enzyme and the substrate causes fluorescence and this fluorescence can be detected utilizing embodiments described herein.

Embodiments described herein may be utilized for a variety of applications and uses. One application includes their use in reflective sample chambers for enhanced luminescence detection of liquid specimens. Such sample chambers may be part of a variety of instruments such as polymerase chain reaction (PCR) devices, microplate readers, and liquid phase separation devices.

Embodiments described herein may enable amplification of luminescent (e.g., fluorescent) signal emanating from a well, an analyte, or both. The wells may have volumes on the order of a nanoliter or smaller (nanowells). Alternatively, the wells may have volumes of a macroliter or smaller (macrowells). Photolithographic and wet etching procedures may be used to fabricate the nanowell on a substrate followed by vapor deposition of a metal (e.g., aluminum) layer. As described herein, the luminescent signal recorded in these structures may be enhanced due to the reflection of the incident and emitted radiation by the metal layer as well as focusing of this light by the curvature of the well surface. While the first effect may amplify the background signal in the entire assay chamber, the latter one may produce signal hotspots around the edges and center of the well. In a non-limiting example, the inventor achieved over a 20-fold enhancement in the luminescence signal upon quantitating it at the central hotspot of the well.

The following examples are put forth so as to provide those of ordinary skill in the art with a complete disclosure and description of how to make and use aspects of the present disclosure, and are not intended to limit the scope of aspects of the present disclosure. Efforts have been made to ensure accuracy with respect to numbers used (e.g. amounts, dimensions, etc.) but some experimental errors and deviations should be accounted for.

### EXAMPLES

### 1. Device and Operation

### 1.1. Device Fabrication

Glass microchips were fabricated using photo-lithographic and wet-etching procedures as detailed below. To realize the metal coating within the nanowells, an aluminum layer (having a thickness of about 100 nm) was deposited on the patterned surface of the top plate using a dual metal evaporator system (Energy Beam Sciences, Inc.). This plate was then immersed in an acetone solution to remove the photoresist layer which also got rid of the aluminum deposited on top of it. Subsequently, the chromium layer on this plate was removed using the chromium etchant leaving behind the aluminum-coated nanowells. Because there was no photoresist or chromium underneath the aluminum layer within the nanowells, it remained intact. The photoresist and chromium layers on the bottom plate were later removed following the same steps. Finally, the microfluidic device was sealed off by bringing the two glass plates in contact with de-ionized water and then allowing the two plates to bond under ambient conditions overnight. The aluminum was determined to adhere well to the glass surface.

Although aluminum films were used for the examples, gold films or silver films on glass substrates (among other films and substrates) may be utilized.

1.1.a. Photolithography and Wet-Etching Process

For fabrication of example microfluidic devices employed in the examples, top and bottom plates made from borosilicate glass were purchased from Telic Company (Valencia, CA). The glass plates came with a thin layer of chromium and photoresist laid down on one of their surfaces. Custom designed photomasks created by Fineline Imaging Inc. (Colorado Springs, CO) were used to pattern the desired nanowell and supporting channel layout onto the top and bottom plates, respectively, using standard photolithographic methods. Following completion of the photo-patterning process, the photoresist layer was cured in a microposit developer MF-319 (Rohm and Haas) and the chromium layer removed from the patterned regions with a chromium etchant (Transene Inc.). A buffered oxide etchant (Transene Inc.) was used to then etch the supporting channel to a depth of about 8 μm, and the nanowells to depths between about 5 μm and about 30 μm. Access holes were drilled at the terminals of the supporting channel on the bottom plate using a microabrasive powder blasting system (Vaniman Inc.) to introduce and purge liquid reagents/sample into and out of the nanowells.

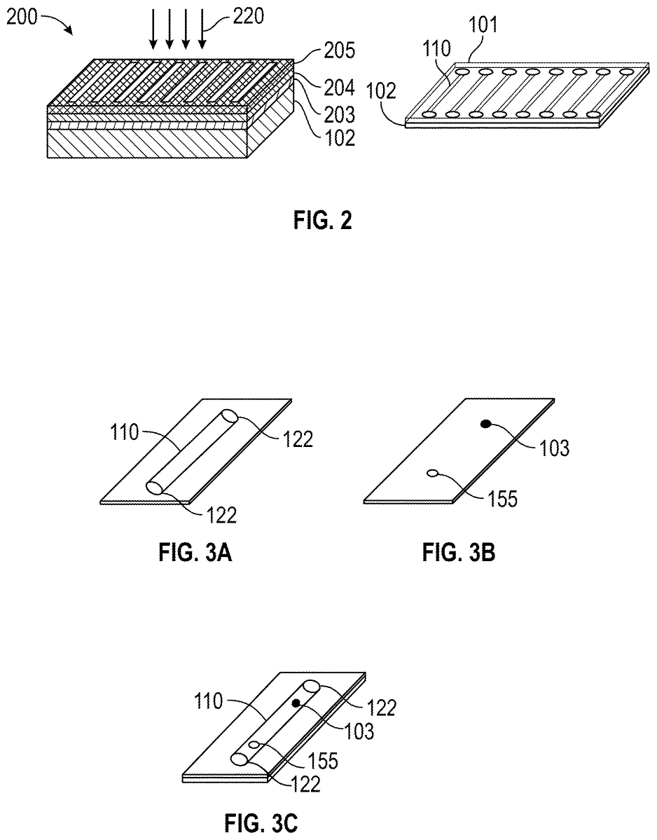

Aluminum (Al, as an example reflective material) was coated onto the channel and well surfaces using vapor deposition. A photoresist layer was applied on the surface except the channel area where Al mirror was patterned. The substrate was then dried in a forced air convection oven at 80° C. for 15 minutes. To fabricate the Al-coated reflecting well in the microchip, about 40 mg Al (99.9%) in metal evaporator boat was used to coat glass substrate for 10 minutes. Metal evaporation was performed using an Emitech K975X thermal evaporator. FIG. 2 shows the microchip fabrication using photolithography assisted by wet etching for channel engraving on the substrate (left panel) and a fabricated microchip utilized for preliminary investigations (right panel).

After cooling the coated substrate was first dipped in an acetone solution that removed the photoresist layer and peeled Al off with it, as the etched area (well and channel) has no photoresist to remove so the Al in that region remains intact. The remaining unwanted layer of chromium was then removed by a chromium etchant (Transene Inc.). As the well is in one glass plate and the channel (used for analyte introduction) in another glass plate, the plates were joined after cleaning deionized water (Milli-Q 18.2 MΩ·cm), to obtain the microdevice. The plates are brought together so that the channel and wells are in phase. In cases where the wells are less than 300 μm in diameter, microscopes may be utilized to align the channel with the wells to make sure the wells were in the center of the channel.

FIGS. 3A and 3B shows the two plates (the first layer 101 and the second layer 102, respectively) and FIG. 3C shows the fabricated microchip. Specifically, FIG. 3A shows the optional channel 110 with access holes 122 for sample introduction and FIG. 3B shows the Al-coated microwell 103 and an uncoated (transparent) well 155 that serve as analysis chambers. The uncoated well 155 serves as a comparative.

Once the glass plates were aligned, a clip was utilized to hold the plates overnight to form silanol bonding between the glass plates. The bonded microchip was then dried in a forced convection oven for two hours.

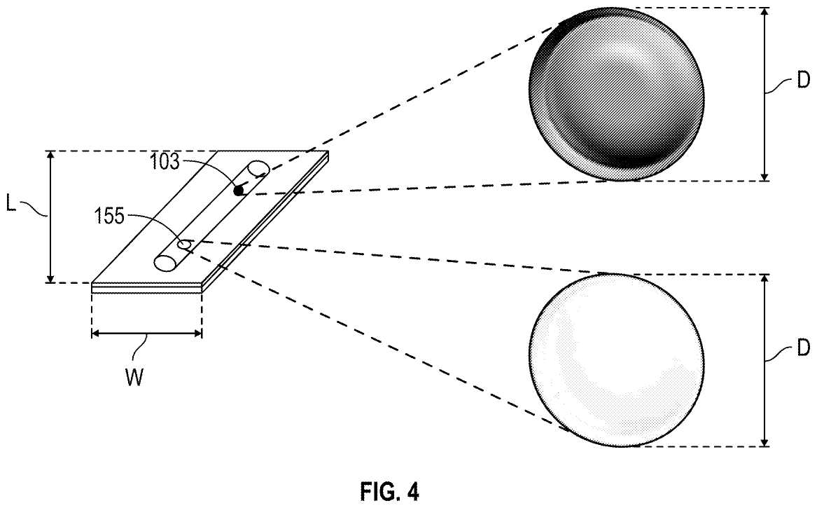

FIG. 4 is a schematic of a fabricated device used for various experiments. The rectangular chip device is about 5.08 cm in length (L) and about 2.54 cm in width (W) while the depth of the well is maintained at about 30 μm. The magnified view of the microwells of about 38 μm in diameter (D) in a ~100 μm wide channel shows the macroscopic view of the microscale footprint. The well microwell (well 103) presents an Al-coated well and the transparent well (uncoated well 155) presents the uncoated regular well as a reference/comparative. The schematic was generated based on experimental design for the microwell that was substantiated by well and channel depth profile using profilometer.

### 1.3. Device Operation

The microchip device was prepared for an experiment by first introducing methanol into it via capillary flow which produced the least amount of gas bubbles in the nanowell. These bubbles were later shrunk and washed away by flowing methanol at high pressures using a syringe pump. Once the gas bubbles were removed or eliminated, the solution within the fluidic network was replaced as needed without emptying it. This process involved filling up one of the access holes with the solution to be introduced while applying vacuum at the other. The nanowell was rinsed with de-ionized water and a sodium phosphate buffer solution sequentially for about 10 minutes (min) each following this process to condition the glass surface.

For characterization of the nanowell platform, fluorescein samples containing varying concentrations of the dye were prepared in the sodium phosphate buffer (about 0.1 M, pH of about 7.4). No reservoirs were attached over the access holes to minimize unwanted pressure-driven flow during an experiment. Liquid evaporation from the channel terminals was minimized by, for example, sealing these ports with adhesive tapes. The fluorescence measurements were made using an epifluorescence microscope (Nikon) with bandpass excitation (from about 450 nanometer (nm) to about 495 nm) and emission (from about 528 nm to about 543 nm) optical filters.

### 1.4. Assays

Horseradish peroxidase assays were performed by introducing a solution of this enzyme prepared in the sodium phosphate buffer (about 0.1 M, pH of about 7.4) containing Amplex Red (about 25 μM) and hydrogen peroxide (about 5 μM). The enzyme reaction was carried out by maintaining an air temperature at about 37° C. around the microchip (measured using a thermometer) through placement of a heating fan close to the device. Without this temperature control, the assay-to-assay variability in the recorded signal may be significantly larger than that reported herein likely due to fluctuations in the room temperature.

The enzyme assays were quantitated using the same epifluorescence microscope (Nikon) but different bandpass excitation (from about 528 nm to about 543 nm) and emission (from about 590 nm to about 650 nm) optical filters. The fluorescence images obtained in the experiments were recorded using a CCD camera (Nikon) and analyzed with ImageJ software. To minimize unwanted signal generation through spontaneous photo-oxidation of Amplex Red, the nanowell region was exposed to the excitation beam for about 1 second(s) during the imaging process through the use of a mechanical shutter. The camera exposure time was chosen to be about 50 milliseconds (ms) in all measurements while a 10× objective was used throughout the study with 1.2× signal gain.

### 2. Non-Limiting Results and Discussion

The inventors explored the well geometry to enhance the realized signal. One aim was to utilize the same incident light for multiple interactions with the matter. The inventors observed emitted signal amplification in microchannels when aluminum (Al) was used as a reflecting surface cured inside the channel. Generally, when excitation light was shined in the channel, the light reflects off the Al surface and strikes the targeted analyte again, which eventually translates into an increase in path length. As signal is proportional to the light path length, a linear relationship was expected as theory suggests. Although the data showed a 2× increase in the path length, the signal amplification was more than two, indicating that there is an additional phenomenon that interplays and yields higher signal amplification.

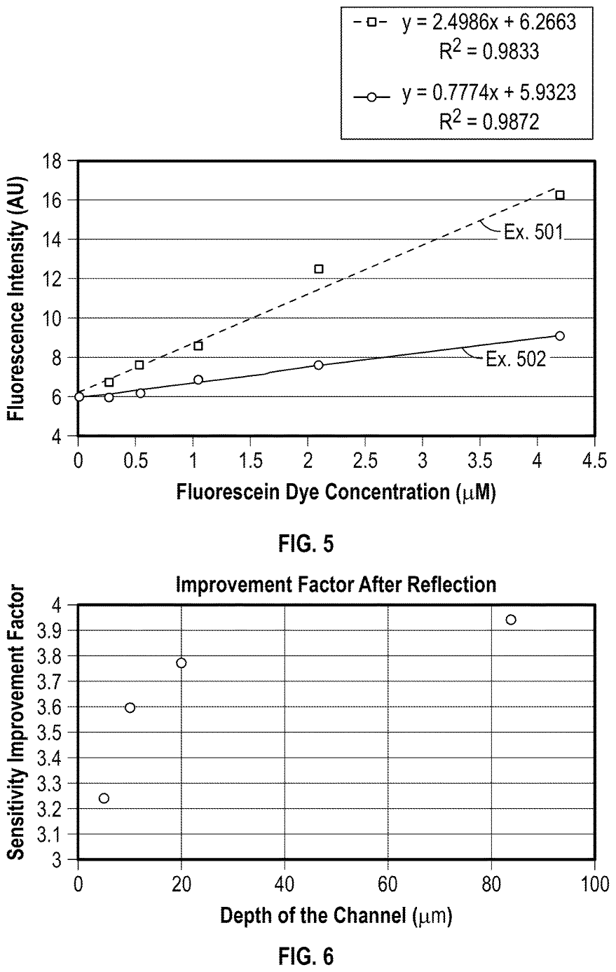

FIG. 5 shows experimental data obtained using a microchip (shown in FIG. 1I) having a channel width of about 1 mm in and a channel depth of about 30 μm. Ex. 501 refers to an Al-coated channel and Ex. 502 refers to an uncoated channel. The data indicates a ~3.2× increase in realized signal calculated from the slope of the calibration curve.

A similar amplification in the signal was observed when the depth of the channel was increased. As shown in FIG. 6, an increasing trend in the signal intensity was observed. Because the depth of the substrate (about 1 mm) limits ability to make more study in deeper channels and the amplification plateaus after about 30 μm in channel depth, a 30 μm deep well was utilized for investigations.

### 2.1. Characterization of Fluorescence Enhancement

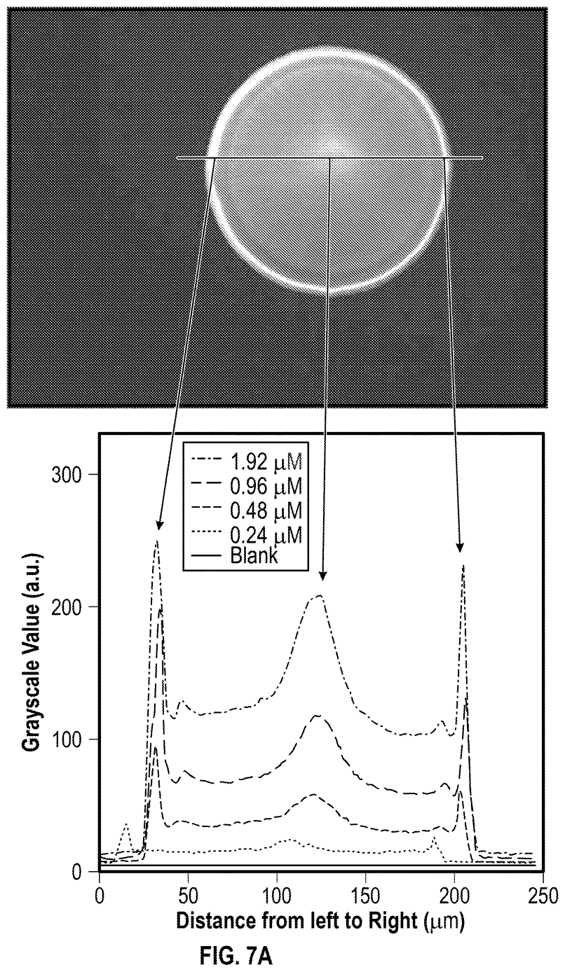

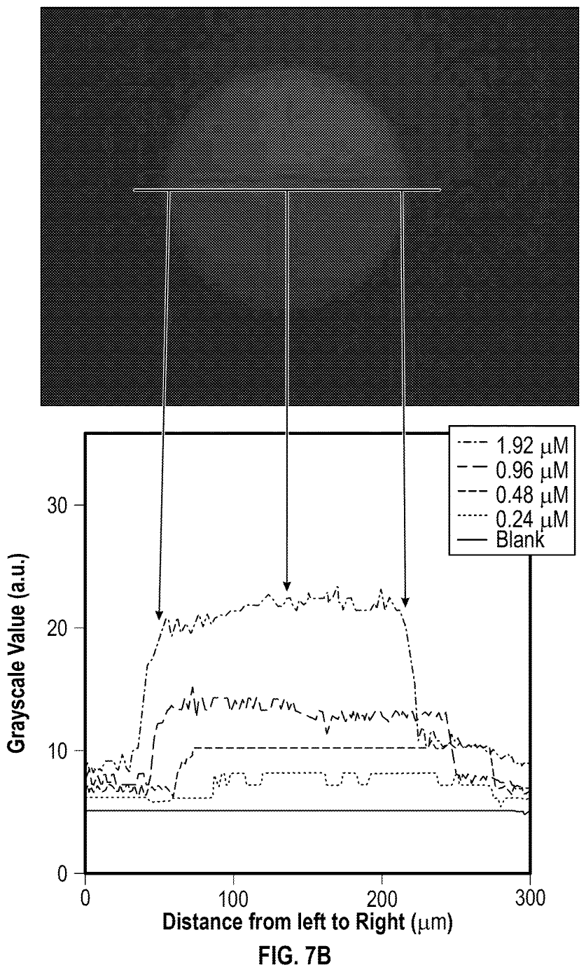

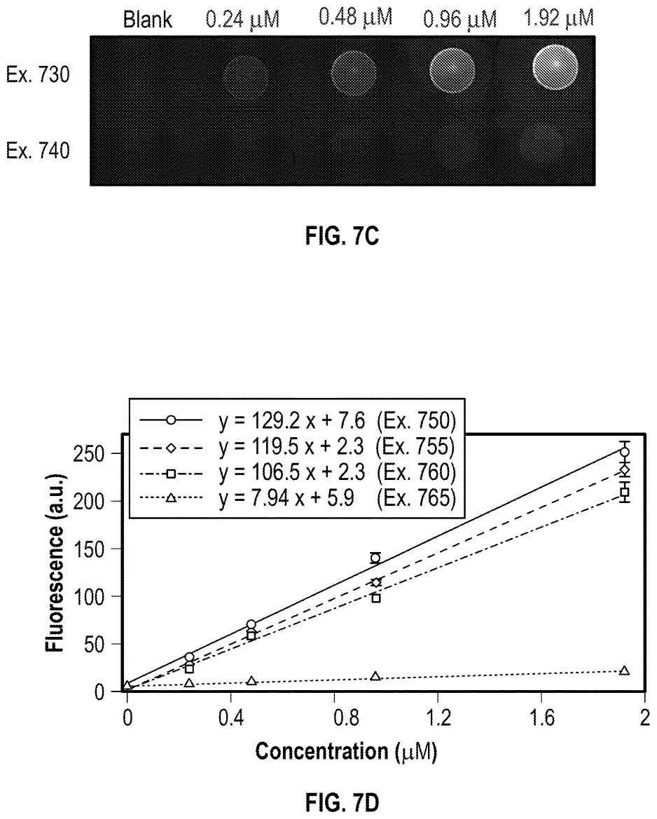

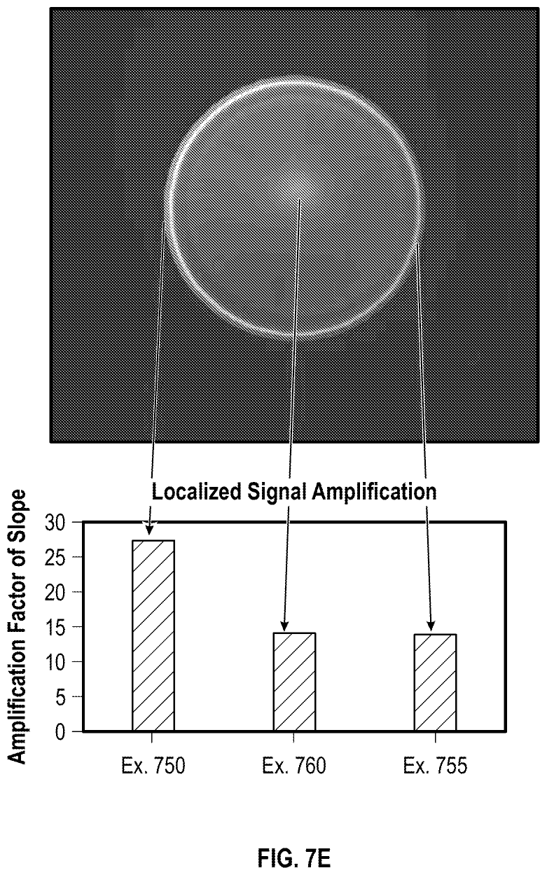

FIG. 7A shows a fluorescence image of a 0.96-μM fluorescein sample contained within a 150-μm-diameter and 30-μm-deep Al-coated circular nanowell. The diameter corresponds to that of the nanowell patterned by the photolithographic process. After wet etching, this diameter may increase to about 200 μm at half-depth due to undercutting. The concentrations for the graph shown in FIG. 7A are 0 μM (blank), 0.24 μM, 0.48 μM, 0.96 μM, and 1.92 μM, and the grayscale value (corresponding to intensity) increases with larger concentrations.

FIG. 7B shows an image of the comparative nanowell having the same shape and dimensions but without a reflective Al metal layer. The concentrations for the graph shown in FIG. 7B are 0 μM (blank), 0.24 μM, 0.48 μM, 0.96 μM, and 1.92 μM, and the grayscale value (corresponding to intensity) increases with larger concentrations. FIG. 7C shows images of Al-coated wells (top panel, Ex. 730) and comparative wells (without Al coating, bottom panel, Ex. 740) with increasing concentration of fluorescein dye-0 μM (blank), 0.24 μM, 0.48 μM, 0.96 μM, and 1.92 μM. FIG. 7D provides corresponding intensity data for the wells containing various concentrations (in units of μM) of fluorescein dye. FIG. 7E shows that the metal-coated well may also be characterized as having localized signal amplification. In FIGS. 7D and 7E, Ex. 750, Ex. 755, and Ex. 760 refer to the left edge of the Al-coated circular nanowell, the right edge of the Al-coated circular nanowell, and the center of the Al-coated circular nanowell, respectively. Ex. 765 refers to the comparative well without Al coating.

A comparison of the images included in FIG. 7A and FIG. 7B shows a substantial enhancement in the fluorescence signal by the aluminum layer. The increase in the signal in the Al coated well is obvious from the bright spot at the center of the nanowell. The brighter spot in the center may be due to the superposition of light bouncing back after striking the side wall of the concerned well. When the well is fabricated, the well is assumed to be a one end closed cylinder; in theory, the well may be conical in shape with a truncated top. This may occur due to non-homogenous etching on the intended surface and deposition of the etched debris in the edges.

The amplification in signal was determined to be at least 10× increase, which is a similar improvement in amplification that was observed with the straight channel. The histograms shown in FIGS. 7A and 7B demonstrate, for example, how the emitted light intensity may vary in space. With the Al-coated well, a Gaussian shape of the emitted light in the center and in the edge was observed. The significant signal amplification is also observed with increasing fluorescein dye concentration from 0 μM to about 1.92 μM and corresponds to the images shown in FIG. 7C (Ex. 730 refers to the Al-coated wells, and Ex. 740 refers to the comparative uncoated wells). It is noted that although both the example Al-coated well and the comparative well showed increased signal, the histogram (FIG. 7B) of the comparative well is pretty flat with no superposition of light observed. Overall, the signal amplification observed in the Al coated well and superposition of light generated a peak value of pixel count in the center of the radius of curvature.

As noted before, and while not wishing to be bound by any theory, the signal enhancement may occur for various reasons. First, the analyte molecules in the metal-coated nanowell are subjected to more radiation due to the optical reflection of the incident light by the aluminum layer (see FIG. 1A). Such reflection automatically leads to a higher fluorescence signal as the light emitted by a fluorophore increases with the amount of incident radiation it is exposed to. Second, the aluminum layer also reflected back some of the radiation emitted by the fluorophores towards the detector that otherwise would not have been recorded, e.g., the fluorescent light emitted in the direction opposite to where the detector is located in FIG. 1A. And third, the curvature of the metal surface in the horizontal and vertical cross sections spatially focused some of the reflected incident and emitted radiation in distinct regions of the nanowell. The first two factors may produce a higher intensity over the entire nanowell whereas the third factor may create signal hotspots around its edges and central region (see FIG. 7A).

Experiments further indicated that the peripheral hotspots stemmed from focusing of the incident light by the curvature of the metal layer in the vertical cross section of the nanowell (see FIG. 1A). This curvature may have resulted from undercutting of the pattern photolithographically transferred onto the top plate during the wet etching process. Also, although the fabrication methods described herein were generally well-developed, the structures produced using them were mostly not absolutely isotropic likely due to spatial and temporal fluctuations in the local wet etching rate. As a result, the curvature of the metal surface in the vertical cross section may not be completely uniform in all locations. This non-uniformity may introduce spatial variations in the intensity of the peripheral hotspot making certain areas appear brighter than the others (see FIG. 7A). The central hotspot, on the other hand, may emerge from focusing of the incident light by the curvature of the aluminum surface in the horizontal cross section of the nanowell (see FIG. 1B). Consequently, this curvature was determined by the pattern photolithographically transferred onto the top plate, and could be generally controlled more accurately in fabrication processes. Deviations in the nanowell shape from that photo-patterned onto the top plate may be noticeable when its depth and diameter were made comparable to each other. These deviations may be a result of the fluctuations in the local wet etching rate which originated from non-idealities in the system, e.g., spatial and temporal variations in the concentration of the buffered oxide etchant due to improper mixing in the reaction vessel. No signal hotspots were observed in the nanowells that lacked the metal layer (see FIG. 7B).

To characterize the focusing effect of the metal layer in the circular nanowells, fluorescein samples were introduced into the wells and the signal intensity was mapped along a straight line running through the central and peripheral hotspots. These measurements for the image included in FIG. 7A showed the left edge of the nanowell to be consistently brighter than the right one with the central hotspot being the dimmest. The peripheral hotspot was brighter than the central one in the nanowell shown in FIGS. 7A-7E as the surface curvature producing the former (determined by the channel depth) was shaper than that generating the latter (dictated by the nanowell radius) and therefore yielded smaller spherical aberrations. The above trend was found to be valid for all fluorescein samples with different dye concentrations imaged in this nanowell (see FIG. 7C and FIG. 7D) which further associated it with the nanowell structure rather than factors such as the angle of incidence for the excitation light. As a result, a highly linear variation in the fluorescence intensity with dye concentration was observed for the peripheral and central hotspots shown in FIG. 7A/7C. The slope of the regression lines fitted to this data then yielded a measure for the sensitivity of the fluorescence signal at the different hotspots. The signal enhancement factor at any hotspot location was subsequently calculated as the ratio of this sensitivity value over that recorded for the nanowell without the metal layer. For the nanowell shown in FIGS. 7A and 7C, the signal enhancement factors for the hotspots around the left edge, right edge, and central region were thus determined to be about 16.3, about 15.0, and about 13.4, respectively. When similar experiments were repeated in a different nanowell with the same dimensions, however, the fluorescence signal at the central hotspot was relatively consistent (RSD <10%) but that at the peripheral hotspots varied to a larger degree (RSD>20%). This result may be due to the greater control over the photolithographic versus the wet etching process.

With reference to FIG. 7E, different intensity profiles are observed for the nanowells, indicating localized hotspots, such as around the circumference of the well (e.g., left edge of the well (Ex. 750) and right edge of the well (Ex. 755)) and the center of the well (Ex. 760). The bar graph shows the highest improvement was achieved for the left edge of the well and the improvement is very similar in case of the center and the right edges. The enhancement in the edges may be due to light reflection from the edges of the side wall and the bottom wall of the well. The difference in signal enhancement may be because fluorescence intensity depends on the incident light intensity. For example, placing the microchip on the microscope stage may also change the intensity of incident light in space and resultant emitted light.

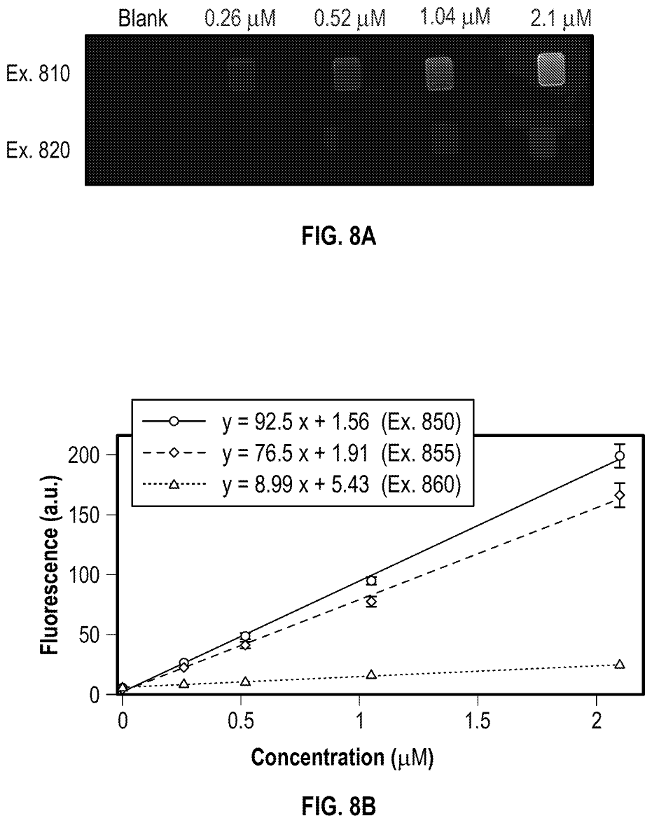

In order to further validate the hypothesis for the origin of the peripheral and central hotspots, additional experiments were performed with rectangular wells (dimensions of 200 μm×150 μm). FIG. 8A shows images of the Al-coated rectangular wells (top panel, Ex. 810) and non-Al-coated rectangular wells as comparatives (bottom panel Ex. 820) containing various concentrations of fluorescein dye-0 μM (blank), 0.26 μM, 0.52 μM, 1.04 μM, and 2.1 μM. FIG. 8B shows the corresponding intensity data. Standard deviations included in FIG. 8B are based on five measurements. In FIG. 8B, Ex. 850 and Ex. 855 refer to the top left edge of the Al-coated rectangular nanowell and the top left corner center of the Al-coated rectangular nanowell, respectively. Ex. 860 refers to the comparative well without Al coating.

As before, the well dimensions corresponded to that of the well design patterned by the photolithographic process. After wet etching, the structure measured about 250 μm×200 μm with quarter-circular corners and a radius of about 25 μm at half-depth. Upon introducing fluorescein samples into these assay chambers, their fluorescent images again showed signal hotspots along the edge of the structure which stemmed from the curvature of the metal surface in the vertical cross section. No hotspot was noticed at the center of the nanowell as its edges, for the most part, did not have a curvature in the horizontal cross section. Signal hotspots were observed at the center of the quarter-circular corners due to a local curvature in the horizontal cross section in these regions. These hotspots were elongated however by the linear edges adjoining the quarter-circular corners. As with the circular nanowell shown in FIG. 7A, the signal hotspots around the edges of the rectangular structure were found to be brighter than those at the center of their corners as shown in FIG. 8A.

The analysis included in FIG. 8B shows a signal enhancement factor of about 10.3 and about 8.5 for the hotspots around the top left edge and top left corner center of the assay chamber, respectively. Under the conditions tested, the signal enhancement factor around the edges of the rectangular wells was lower than that for the circular design despite both having the same depth. This may have occurred as the focusing effect of the metal surface curvature in the horizontal cross section may also have contributed to the brightness of the signal hotspot along the edges of the nanowell. Therefore, a dimmer central hotspot may automatically reduce the fluorescence intensity around the nanowell edges. The brightness of the hotspots at the center of the quarter-circular corners on the other hand may be influenced by multiple factors. For example, while a tighter radius of curvature (e.g., about 25 μm) may produce a brighter hotspot than that observed for the 150-μm-diameter circular nanowell shown in FIG. 7A due to smaller spherical aberrations, the focusing power of a quarter-circular mirror is significantly lower than that of a fully-circular one. Additionally, the fluorescence intensity around the nanowell edges may also have contributed to the brightness of the hotspot at the center of the quarter-circular corners. Meaning, for example, dimmer hotspots around the edges of the quarter-circular corners may automatically produce lower fluorescence intensities around their centers.

In view of these factors, the observation of fainter hotspots at the center of the quarter-circular corners of the rectangular nanowell compared to that seen in FIG. 7A was considered reasonable. The above measurements were also performed in triangular and ellipsoidal nanowells which again yielded hotspot distributions consistent with those observed for the rectangular and circular structures. Moreover, the enhancement factor for these hotspots was lower than that recorded for a circular nanowell with similar dimensions.

Overall, when comparing the data from the circular and rectangular wells, the greatest enhanced signal and LOD improvement may occur if the well is made small enough so that the rectangle becomes a circle-like structure, and the light from the edges may merge and generate intense pixels for analysis.

### 2.2. Effect of Nanowell Dimensions

The results included in FIGS. 7A-7E and 8A-8B indicated that a circular geometry may be best for producing the brightest hotspot at the center of any suitable nanowell. Arguably, it should be possible to further maximize the intensity of this central hotspot by altering the dimensions of the circular nanowell.

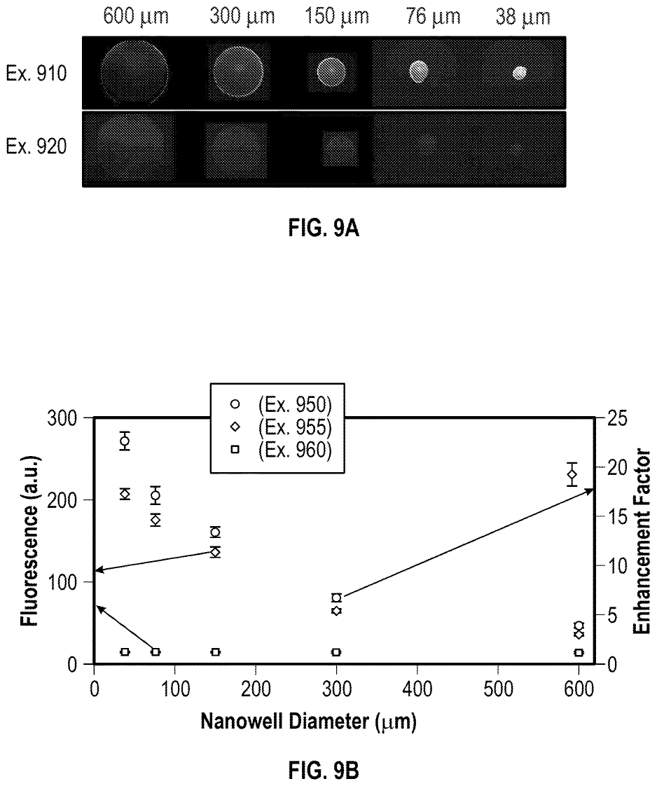

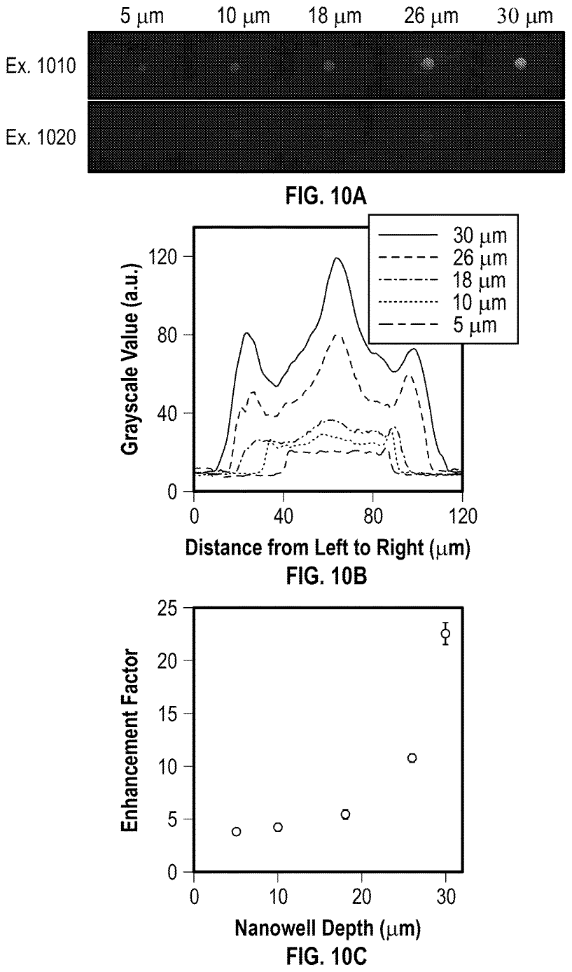

To this end, the influence of the diameter of a circular nanowell on the brightness of its central hotspot for 30-μm-deep wells was investigated. FIG. 9A shows fluorescence images of circular nanowells of varying diameters (from left to right: 600 μm, 300 μm, 150 μm, 76 μm, and 38 μm) with an Al coating (top panel, Ex. 910) and without an Al coating (bottom panel, Ex. 920). The uncoated wells are comparatives. All nanowells in these images were about 30 μm deep and contained about 1.25 μM of fluorescein sample. FIG. 9B shows fluorescence readings (left y-axis) and the corresponding signal enhancement factor (right y-axis) from the images shown in FIG. 9A. The x-axis in FIG. 9B is nanowell diameter in units of μm. The signal enhancement factor was calculated based on the slope of the regression lines fitted to the data obtained by imaging fluorescein samples of varying concentrations. The standard deviations included in FIG. 9B are based on five independent measurements. In FIG. 9B, Ex. 950 and Ex. 955 refer to Al-coated nanowells. Ex. 960 refers to the comparative well without Al coating.

The data shown in FIGS. 9A and 9B indicated an increasing fluorescence enhancement in the metal-coated circular nanowells upon reducing its diameter from about 600 μm to about 38 μm. That is, improvements in sensitivity may be achieved with smaller diameter wells. Moreover, while both the peripheral and central hotspots grew brighter for smaller assay chambers, the intensity of the latter actually exceeded the former for the 38-μm-diameter nanowell under the conditions tested. Again, note that the diameter mentioned above corresponded to that of the pattern transferred by photolithography which ended up being about 90 μm upon wet etching the nanowell to a depth of about 30 μm.

A brighter central hotspot in the smaller nanowells may be a result of two factors. First, the tighter radius of curvature produced a highly focused central hotspot due to smaller spherical aberrations. Second, the peripheral and central hotspots started overlapping for smaller circular nanowells enhancing each other's intensity. Unwanted non-uniformities in the etching rate around the periphery of the circular nanowells may produce noticeably oblong structures for photo-patterned diameters less than about 100 μm.

Circular nanowells etched to a depth of 30 μm and a photo-patterned diameter of 38 μm were also investigated. This particular design yielded the highest signal enhancement factor of about 22.6 among all nanowells investigated (see FIG. 9B). Based on the findings, improved designs may be attained when the peripheral and central hotspots are completely merged unlike the separation seen between the two in the images included in FIG. 9A. Overall, the increased sensitivity (increased amplification) may be due to the circular geometry of the well with decreasing diameter helps to collect light and generation of the bright hotspot.

COMSOL simulations are currently being developed to explore further enhancement in the optical focusing effects described in this work through changing of the surface curvature and material properties. Such designs may be made by a microfabrication method, e.g., hot-embossing, which may provide greater control over the nanowell dimensions, surface curvature, and the optical properties of the metal layer.

The signal enhancement factors included in FIG. 9B were estimated based on the slope of the regression lines fitted to the fluorescence data at the central hotspot for varying dye concentrations. Also, upon decreasing the diameter of the nanowells with no metal layer, a statistically insignificant change in the fluorescence signal was recorded. Thus, the reported improvement in the signal enhancement factor for smaller circular nanowells represents an actual gain in the sensitivity of fluorescence measurements.

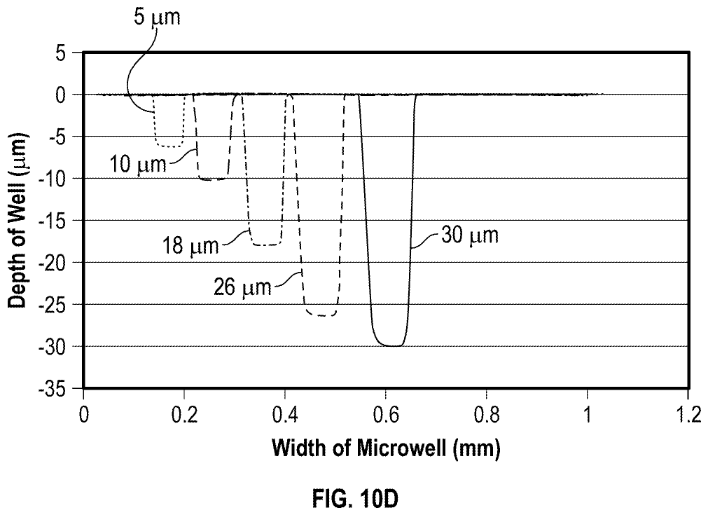

To understand the effect of the nanowell depth on the device performance, additional experiments were performed using 38-μm-diameter wells but etched to shorter depths between about 5 μm and about 30 μm. Each well contained 0.67 μM of fluorescein dye. Results are shown in FIGS. 10A-10C. FIG. 10A shows fluorescence images of the circular Al-coated nanowells (top panel, Ex. 1010) non-Al-coated rectangular wells as comparatives (bottom panel, Ex. 1010) having depths of about 5 μm, about 10 μm, about 18 μm, about 26 μm, and about 30 μm. FIG. 10B shows fluorescence profiles observed of the wells of different depths in the circular nanowells of FIG. 10A recorded along a straight line running through their central and peripheral hotspots. FIG. 10C shows the signal enhancement factor for the Al-coated circular nanowells estimated from the fluorescence intensity recorded at their central hotspots. The enhancement factor was calculated based on the slope of the regression line fitted to the data obtained by imaging fluorescein samples of varying concentrations. The standard deviations included in FIG. 10C are based on five independent measurements.

FIG. 10A shows an increasing fluorescence intensity in these Al-coated nanowells upon increasing their depths (top panel, Ex. 1010). This trend may result from, for example, a reduction in the optical path length and/or the dimming of the hotspots at the periphery and center of the circular structures, among other factors. For shallower nanowells, the undercut region with a curvature in the vertical cross section got narrower reducing the amount of light reflected by it causing the peripheral hotspots to become both fainter and thinner. Overall, the images show how bright the hotspots appear in Al-coated relative to those wells without coatings, and show how the fluorescence intensity may be manipulated by changing well depth. The images also show appearance of hotspots in the center of the well with increasing depth of the wells.

The fluorescence profiles shown in FIG. 10B indicated that narrow undercut regions may also dim the central hotspot and may decrease its size. Overall, these factors may diminish the brightness of the peripheral and central hotspots and may reduce their overlap in spite of shallower nanowells having smaller diameters at their half-depth. Consequently, a sharp decrease in the signal enhancement factor was observed in FIG. 10C for lower nanowell depths which plateaued to a value that was determined by the reflection of the incident and emitted radiation by the flat regions of the metal surface.

FIG. 10D shows depth profiles of the different Al-coated wells shown in FIG. 10A. Here it was determined that the depth profiles are very flat for shallower wells (e.g., 5 μm) while deeper wells (greater than 5 μm) tended to be more circular in shape.

Some of the nanowells investigated had volumes on the order of about 0.1 nL and therefore contained over 106 fluorescein molecules even for the most dilute sample used. Moreover, these molecules were distributed uniformly within the nanowell with a majority of the molecules residing over about 1 μm away from the metal layer. As a result, the reported phenomenon is unlikely to be related to surface-enhanced fluorescence although the separation distance between the metal layer and the fluorescence hotspot may be unclear.

In addition, and under the conditions tested, it was determined that the central hotspots in the circular chambers actually start dominating the peripheral ones for smaller diameters. Therefore, measurements made in these regions may be less noisy and may also yield higher signal intensities.

### 2.3. Different Metal Coatings

Beyond aluminum, gold (Au), silver (Ag), and other materials were investigated. With respect to well dimensions, similar trends for signal amplification and enhancement were observed. It was determined that Al-coated wells outperformed Au-coated wells by a factor of about 2 under the conditions tested.

### 2.4. Horseradish Peroxidase Assays

Having established the quantitative nature of the signal enhancement platform using dye samples, an enzyme assay was performed to further demonstrate its utility for making sensitive analytical measurements. Horseradish peroxidase (HRP) samples were prepared for this purpose that were quantitated using the Amplex Red (AR) enzyme substrate. AR is a colorless reagent that is catalyzed by HRP to the fluorescent species, resorufin, in the presence of hydrogen peroxide (H₂O₂).

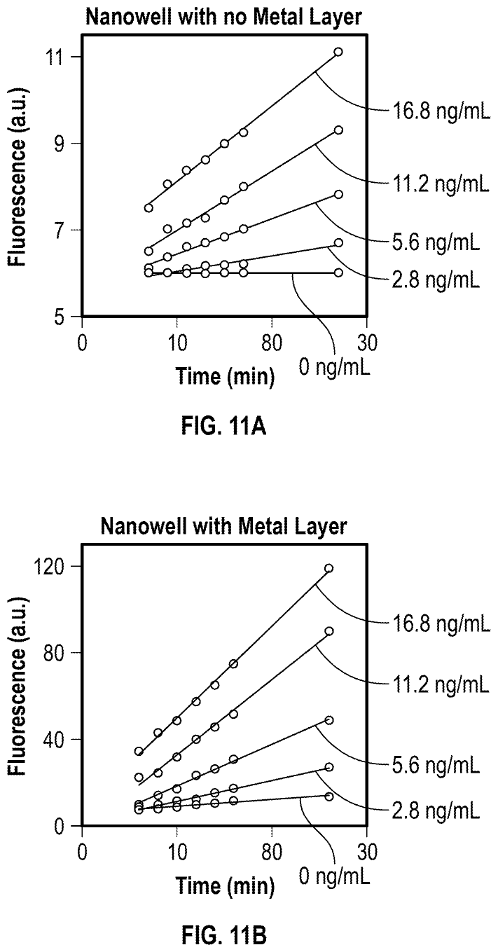

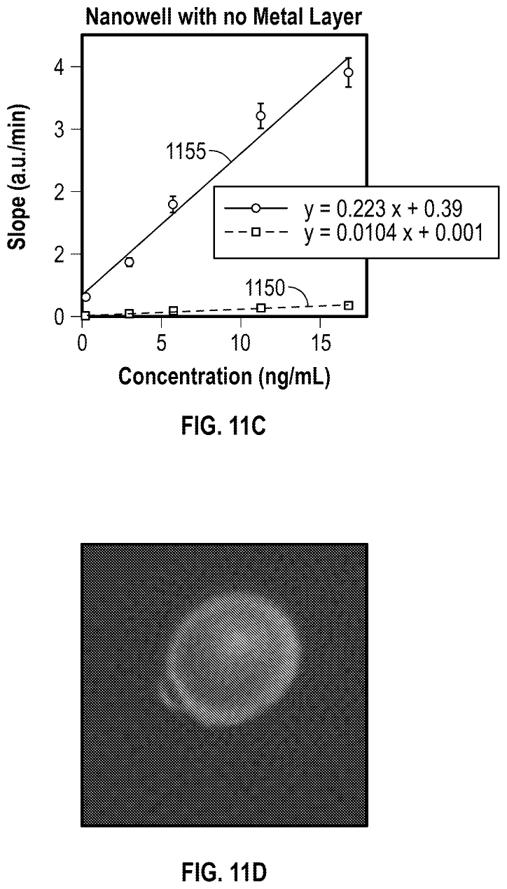

For the experiments, samples containing AR (about 25 μM), H₂O₂ (about 5 μM), and HRP (from 0 ng/ml to about 16.8 ng/ml)—all final concentrations-were prepared in a sodium phosphate buffer (about 0.1M, pH of about 7.4) by premixing these reagents before introducing the samples into the nanowells. A 6-minute delay was maintained between the moments when AR was added to the sample and the first fluorescence measurement was made. This delay was used to introduce the sample into the nanowell and ready the system for data collection. The metal-coated and bare nanowells were then imaged alternatively over a period of about 20 min to quantitate the HRP assay. For this study, circular nanowells with a photo-patterned diameter of about 38 μm and depth of about 30 μm were used. In FIG. 11A (nanowell without metal layer) and FIG. 11B (nanowell with metal layer) the fluorescence intensities recorded at the central hotspot of these nanowells have been plotted against the enzyme reaction time which showed a linear relationship between the two quantities. This trend indicated saturation kinetics for the enzyme reaction under the experimental conditions. In addition, the slope of the regression lines fitted to the data included in FIG. 11A and FIG. 11B was observed to increase linearly with the HRP concentration, demonstrating the quantitative nature of the assay.

As shown in FIG. 11C, the regression lines fitted to the data included in FIGS. 11A and 11B produced a ~21.4-fold higher slope for the metal-coated nanowell (Ex. 1155) compared to that recorded for the one without the metal layer (comparative, Ex. 1150). Additional experiments showed that the use of the metal layer reduced the limit of detection for HRP from a value of about 2.3 ng/ml to about 0.12 ng/ml in the circular nanowells with a photo-patterned diameter of about 38 μm and depth of about 30 μm. These estimates were based on a signal-to-noise ratio of about 3 for the blank sample and compared the wells with the enhancement in the slope of the calibration line included in FIG. 11A. The measurements yielded a linear range for the metal-coated nanowells (from about 0.12 to about 23 ng/ml) and unmodified glass counterparts (from about 2.3 to about 70 ng/ml). FIG. 11D shows a fluorescence image of the metal-coated nanowell containing about 16.8 ng/mL HRP sample after about 26 minutes of enzyme reaction.

Note that the enzyme reaction continues beyond the 26-minute period indicated in FIGS. 11A and 11B. However, the above enzyme assay was quantitated based on the rate of increase in the fluorescence intensity (kinetic format) rather than the magnitude of this signal at the end of the assay period (end-point format) as the former approach may produce more consistent results. This consistency may be compromised in the end-point format as the background fluorescence (at the initial time) may vary significantly across different glass microchannels. The kinetic format may eliminate any contribution from this variation on the standard deviation of the measurements. Additionally, microfluidic ELISAs developed may yield limits of detection (LOD) for the target analyte that are either lower or comparable to those obtained using commercial microwell kits. Therefore, the signal enhancement described in this work may be expected to reduce the LOD for microfluidic ELISAs and other HRP-based immunoassays by at least an order magnitude compared to that realizable on their microwell counterparts. Furthermore, it was noted that the signal enhancement factor for the HRP assay described above was similar to that observed for the fluorescein samples used in the characterization experiments indicating the minimal influence of the excitation/emission wavelength for the fluorophore on measurements at least in the visible spectrum.

The results clearly establish enhancement in fluorescence detection by over 20-fold using metal-coated nanowells, detecting about 200 HRP molecules. Single-molecule detection of HRP has been reported using fluorescence microscopy even without employing any strategies to focus the emitted radiation. In that work, however, the measurements were performed in assay wells that had volumes over 1000 times lower than those herein. Additionally, larger signal-to-noise ratios were realized using an Electron Multiplication CCD imaging system whereas the experiments herein used a CCD camera for assay quantitation.

In view of these facts, metal-coated nanowells described herein have the potential to enable fluorescence detection of a small number of molecules at larger signal-to-noise ratios or realize lower concentration detection limits than currently possible. For example, embodiments of the metal-coated nanowells described herein may be utilized to reduce the concentration detection limits for PCR-based methods and ELISA-based methods using microplate readers. For example, embodiments described herein may be utilized for analyzing 10 μL or smaller liquid samples with high sensitivity that commercial microplate readers are generally incapable of quantitating.

### 2.5. Scale-Up of Well Volumes in the Range of 10-150 μL & 3D Printing

The scaled up volumes of the wells for this Section 2.5 were in the range of about 10 μL to about 150 μL. The metal-coated nanowells developed in previous examples of this had volumes on the order of nanoliters and therefore may not be suitable for various analytical applications. For example, PCR and immunoassay methods typically employ sample volumes in the range of 10-100 μL which means that a majority of the sample in these applications will remain undetected in smaller nanowells of the previous examples which may compromise analyte detection sensitivity. In addition, it may be challenging to read the signal from the smaller nanowells of the previous examples using a commercial plate reader as their shorter dimensions (diameter <50 μm) utilizes precise alignment with the optical detection system. The inventors also found that the incident and/or emitted radiation in the nanowells may be focused more efficiently by scaling up their dimensions as that allows a greater control over the surface curvature on their bottom wall. In this situation, the inventors pursued two different approaches for scaling up the dimensions of the metal-coated nanowells.

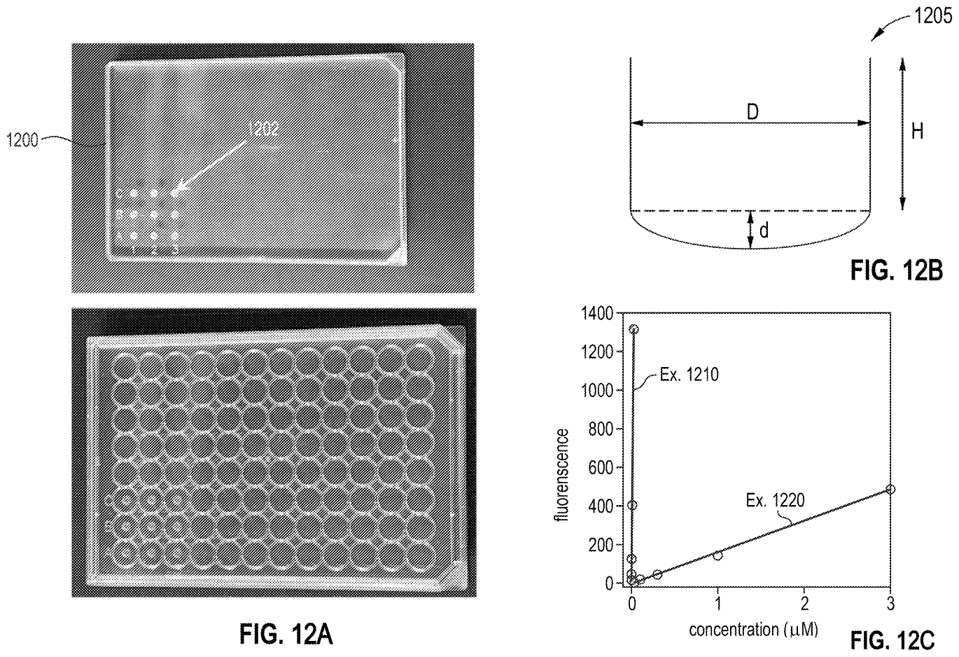

In the first approach, well structures were micromilled on a polycarbonate sheet (top panel of FIG. 12A) in a machine shop facility to realize diameters (D) in the range of 1-5 mm at its open edge with volumes of about 10 μL. COMSOL simulations were performed using the Ray Optics module to perform a preliminary investigation of the dimensions and surface curvature of the sample well. These simulations suggested that for wells with a 3 mm diameter at its open end, a choice of d=1 mm and H=2 mm, would yield over a 500-fold improvement in the fluorescence signal, where “H” refers to a height of a substantially straight sidewall of the well 1205 and “d” refers to the depth of the curved portion of the well 1205 shown in FIG. 12B.

Sample wells with the above dimensions were then milled on a polycarbonate plate to test these predictions. As shown in FIG. 12A, the polycarbonate sheet 1200 was cut to the dimension of a commercial microwell plate and the micromilled wells 1202 (FIG. 12A) were positioned such that their centers aligned with those of the microwells in the commercial plate (bottom panel of FIG. 12A). Additionally, an aluminum layer was deposited in the micromilled wells using a dual metal evaporator system to realize the reflective surface for the experiments. The inventors further explored smoothening the micromilled well surfaces by treating them with ammonium hydroxide for different time periods.

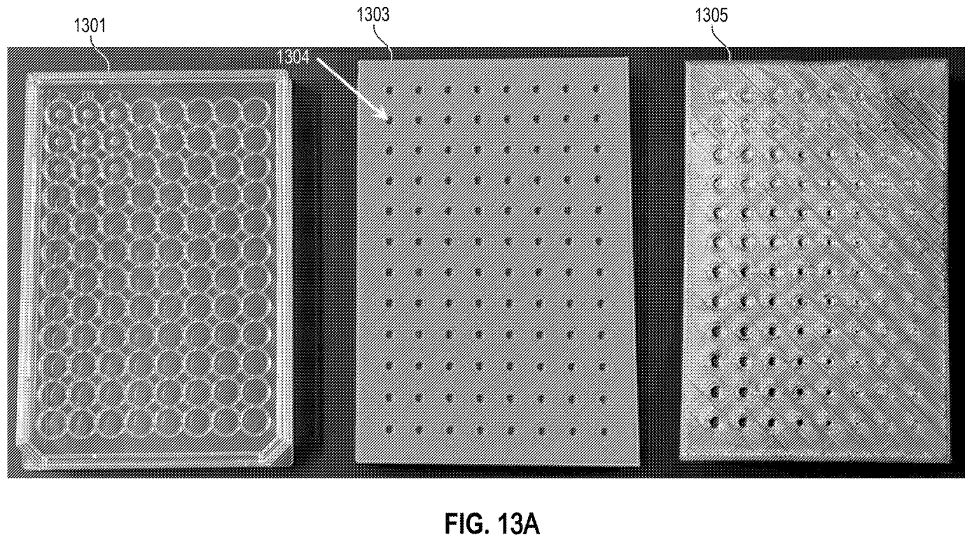

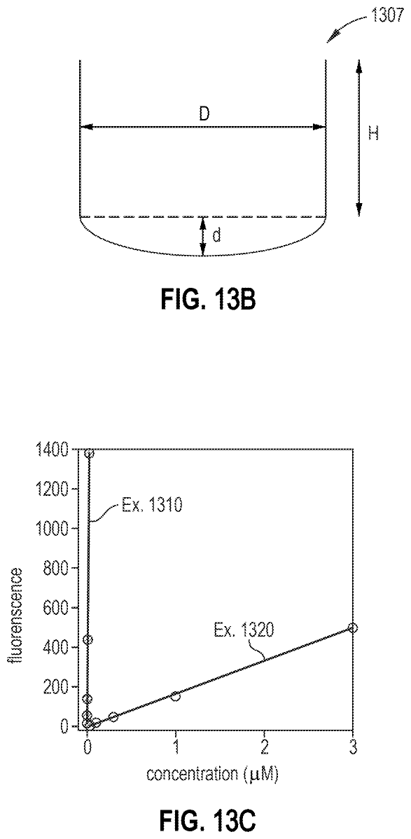

In the second approach, and as shown in FIG. 13A, similar sized sample wells 1310 (FIG. 13B) were prepared by 3D printing them with a polylactic acid (PLA) filament using a fused deposition modeling printer. Again, the 3D printed wells were created on a sheet that had the same dimensions as a microwell plate with their centers matching those of the microwells in a commercial plate. In both the polycarbonate and polylactic acid devices, the wells were produced by stacking a hollow cylinder over a hollow ellipsoid. No cover plates were used in either of these devices when making the fluorescence measurements. In FIG. 13A, the optical image 1301 (left panel) shows micromilled sample wells' centers aligned with those of the microwells in a commercial available microwell plate. The middle panel of FIG. 13A shows an optical image 1303 of a 3D-printed PLA plate that is not coated with metal and a sample well 1304 identified. The right panel of FIG. 13A shows an optical image 1305 of a 3D-printed aluminum coated PLA plate. The aluminum coating was accomplished using a dual metal evaporator.

Initial experiments with the polycarbonate sample wells showed that the aluminum layer deposited on the bottom wall of the well was frequently washed out upon introduction of a liquid into the well. This may have been due to the fact that micromilled polycarbonate sheets can be significantly roughened during the fabrication process which can also adversely affect the adhesion of metal layers deposited on them. Treatment of the well surface with ammonium hydroxide was utilized to reduce this roughness and improve the adhesion of metal layers to them. For example, upon treating the polycarbonate well with a 10% ammonium hydroxide solution for 4 hours, the physical stability of the metal layer (for example, aluminum layer) was substantially improved. These wells were later used to record the fluorescence signal in wells with and without the aluminum layer. Fluorescein samples of varying concentrations prepared in a 10 mM sodium phosphate buffer (pH 7.2) were used in these measurements which were made using a commercial microplate reader.

Results included in FIG. 12C showed about 268-fold improvement in the recorded fluorescence signal upon the inclusion of the aluminum layer in the device, when comparing the metal coated well (Ex. 1210) with the comparative uncoated well (Ex. 1220). This result corresponded to over a 10-fold improvement relative to the data obtained using uncoated nanowells. The data for Ex. 1210 appears vertical because the concentration changes are very small relative to the scale of the x-axis. While the experimental findings did not entirely match the COMSOL simulations which predicted about a 500-fold improvement for the micromilled wells, the two results were deemed to be matching satisfactorily in view of the assumptions made in the simulation model. In particular, this model had assumed a 92% reflectance of the incident and emitted radiation over the entire well surface which may not be true due to non-uniformities in the quality of the metal coating.

With respect to the 3D-printed aluminum coated plates, the aluminum coating was found to be physically stable during washing steps. As shown in FIG. 13C, The 3D-printed aluminum coated plates (Ex. 1310) yielded fluorescence data comparable to that recorded for the comparative polycarbonate device (Ex. 1320) as measured using a commercial microplate reader. The wells 1307 in the 3D printed platform were chosen to be similar in dimensions (3 mm diameter at its open end, a choice of d=1 mm and H=2 mm) as those fabricated on the polycarbonate device for comparison purposes. The data for Ex. 1310 appears vertical because the concentration changes are very small relative to the scale of the x-axis.

### 2.7. Fluorescence Signal Enhancement Using a Convex Sample Meniscus

In the experiments described above with the polycarbonate and 3D printed devices, the liquid meniscus around the center of the sample well was at least 100 μm below its top edge (e.g., 100 μm below its opening). As a result, this meniscus was concave in shape and somewhat diverged the light beam incident on it. During the experiments, however, it was observed that the signal readout may be significantly improved when the sample bulged out the well producing a convex air-liquid interface. Here, the meniscus was made convex by introducing sample volumes larger than that of the well and the fluorescence signal was recorded by the microplate reader.

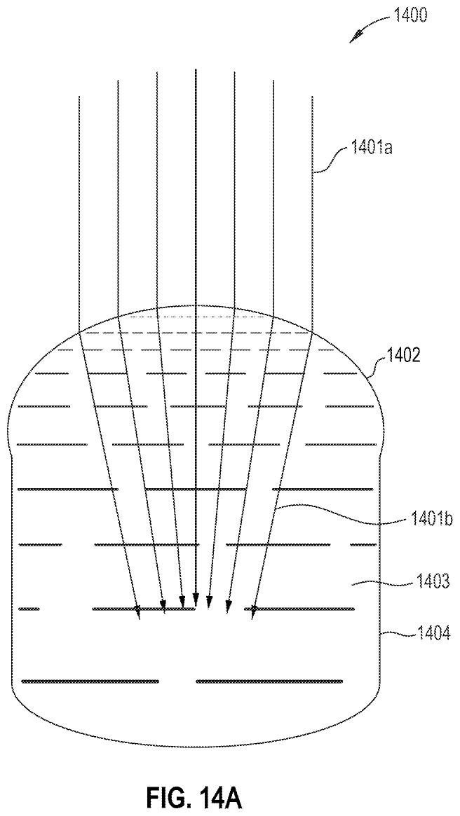

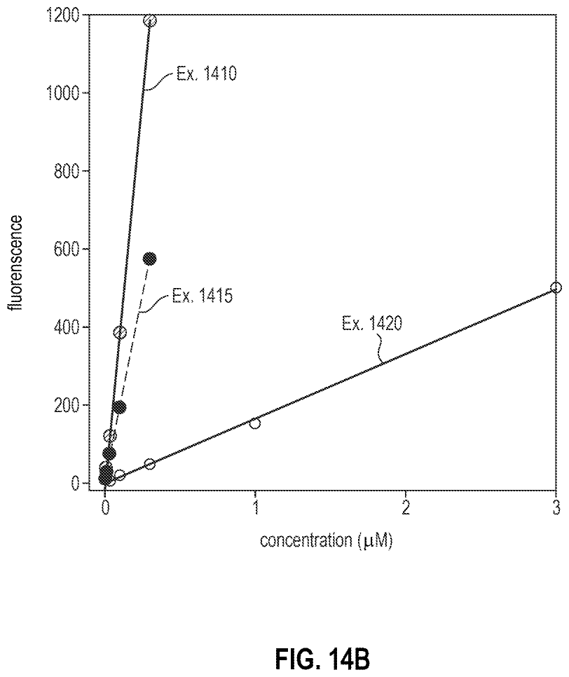

FIG. 14A is a schematic 1400 that shows a well 1404 filled with a liquid sample 1403. FIG. 14A also shows how the incident light 1401a becomes focused by the convex sample meniscus 1402. As shown, the, convex sample meniscus 1402 extends beyond the opening of the well 1404. The change in the focus of the incident light is shown schematically by arrows 1401b.

To characterize the signal enhancement due to the convex air-liquid interface, fluorescein dye samples were prepared and pipetted into the polycarbonate and 3D printed wells. Again, COMSOL simulations were performed using the Ray Optics module to conduct a preliminary optimization of the dimensions and curvature of the convex sample meniscus. These simulations suggested that for wells with a 3 mm diameter at its open end, d=1 mm and H=0 mm, use of a 15 μL sample volume would yield about a 25-fold improvement in the fluorescence signal. The volume of the sample well was estimated to be about 10 μL. In these experiments with the convex sample meniscus, no metal layers were deposited in the wells to eliminate any reflection from the bottom wall. All fluorescence measurements in this study were made using a commercial microplate reader.

To validate the COMSOL predictions, experiments were performed on a 3D printed plate using a commercial microplate reader as the readout device. FIG. 14B shows selected results. Table 1 shows the examples tested. No metal was deposited on the sample wells. Examples 1410 and 1415 have a convex sample meniscus. Example 1420 serves as a comparative example having a concave sample meniscus (liquid sample meniscus below the well opening)

TABLE 1

| | | | Liquid volume |
|---|---|---|---|
| Example No. | Well | Meniscus | of sample |
| Ex. 1410 | No metal coating | Convex | 15 μL |
| Ex. 1415 | No metal coating | Convex | 12 μL |
| Ex. 1420 | No metal coating | Concave | 8 μL |

Overall the results shown in FIG. 14B show a significant improvement in fluorescence sensitivity when using a convex sample meniscus. For example, a ~23.7-fold improvement in the sensitivity of fluorescence measurements was observed when using 15 μL of sample (Ex. 1410) versus 8 μL of sample (Ex. 1420). A ~11.3-fold improvement in the sensitivity of fluorescence measurements was observed when using 12 μL of sample (Ex. 1415) versus 8 μL of sample (Ex. 1420). Overall, the results demonstrate an enhancement in fluorescence signal when using a convex sample meniscus.

It is noted that the fluorescence signal was obtained after subtracting the corresponding reading for a blank sample. As shown in FIG. 13, the blank reading for a green 3D printed plate (optical image 1303) was about 200 (as shown in FIG. 13C) which reduced by about a factor of 5 upon using a black polylactic acid filament Preliminary experiments showed that this change in the color of the polylactic acid plate affected the measurements with the convex and concave liquid meniscii to similar extents, and therefore did not lead to any additional improvement in the fluorescence detection sensitivity of the device.

### 3. Non-Limiting Conclusions

Results provided herein demonstrate a significant improvement in the sensitivity of fluorescence measurements performed in fluidic nanowells coated with a metal layer. The noted improvement may occur, for example, due to the reflection of the incident and emitted radiation by the metal layer as well as the focusing of this light by the curvature of the nanowell surface. While the first effect may amplify the background signal in the entire assay chamber, the latter one may produce signal hotspots around its edges and central region. Experiments also indicated that these peripheral and central hotspots may stem from focusing of the incident light by the curvature of the metal layer in the vertical and horizontal cross sections. Under the conditions investigated, the central hotspots were observed to produce higher and more consistent signal than the peripheral ones. A signal enhancement factor of about 22.6 was realized based on wells that could be fabricated using photolithographic and wet etching methods. Other fabrication techniques may also be utilized such that the hotspots may be merged within a smaller detection zone.

The quantitative assays using horseradish peroxidase samples were demonstrated on the nanowell designs that yielded signal enhancement factors consistent with those recorded in the characterization study with a fluorescent dye. Further, embodiments described herein may also be utilized to enhance other luminescence-based detection methods such as chemiluminescence and electrochemiluminescence, among others.

Results provided herein also demonstrate a significant improvement in the sensitivity of fluorescence measurements performed in fluidic nanowells fabricated from PLA. The results also demonstrate that samples with a convex meniscus show improved fluorescence sensitivity.

Embodiments described herein generally relate to luminescent detection devices and methods for luminescent detection. Embodiments described herein also generally relate to methods of detecting an analyte in a sample. Overall, embodiments of the present disclosure enable luminescence signal amplification.

### Embodiments Listing

The present disclosure provides, among others, the following aspects, each of which may be considered as optionally including any alternate embodiments:

Clause A1. A device for luminescence detection, comprising:
a first layer comprising an optically-transparent material, the first layer having a first surface and a second surface opposite the first surface;
a second layer comprising:
   a well comprising:
      an opening, the opening formed in the second layer and facing the first surface of the first layer;
      a bottom wall disposed opposite the opening; and
      a sidewall extending between the opening and the bottom wall, the sidewall having a first region extending from the opening and a second region extending from the first region to the bottom wall, the first region having a substantially constant or constant radius and the second region having a first radius adjacent to the first region and a second radius adjacent to the bottom wall, wherein the second radius is smaller than the first radius; and
   an optically reflective metal layer disposed over at least a portion of the bottom wall and the sidewall of the well.

Clause A2. The device of Clause A1, wherein the radius of the second region decreases at a uniform rate from the first radius of the second region to the second radius of the second region.

Clause A3. The device of any one of Clause A1 or Clause A2, wherein the radius of the second region decreases at a non-uniform rate from the first radius of the second region to the second radius of the second region.

Clause A4. The device of any one of Clauses A1-A3, wherein the bottom wall is curved or flat.

Clause A5. The device of any one of Clauses A1-A4, wherein the second region comprises a focal point positioned along a vertical axis of the well and between a center of the bottom wall and a volumetric center of the well.

Clause A6. The device of any one of Clauses A1-A5, wherein the well comprises:
a first radius of curvature extending from a volumetric center of the well to the sidewall; and
a second radius of curvature extending from the volumetric center of the well to the bottom wall of the well, the second radius of curvature perpendicular to the first radius of curvature.

Clause A7. The device of any one of Clauses A1-A6, wherein the well has a volume that is from about 500 nL to about 100 μL, the volume defined by a diameter (or width) in one dimension of the opening, a diameter (or width) in one dimension of the bottom wall, and a depth measured from an opening surface to the bottom wall.

Clause A8. The device of Clause A7, wherein the volume of the well is from about 1 μL to about 30 μL.

Clause A9. The device of any one of Clauses A1-A8, wherein: the opening of the well has a diameter (or width) of about 8 mm or less, or about 300 μm or less; a depth of the well from the opening to the bottom wall that is about 4 mm or less, or about 100 μm or less; or combinations thereof.

Clause A10. The device of Clause A9, wherein: the diameter of the opening is from about 160 μm to about 440 μm, or from about 20 μm to about 60 μm; the depth is from about 80 μm to about 220 μm, or from about 15 μm to about 45 μm; or combinations thereof.

Clause A11. The device of any one of Clauses A1-A10, wherein the optically reflective metal layer has a thickness that is from about 50 nm to about 150 nm.

Clause A12. The device of any one of Clauses A1-A11, wherein: the optically reflective metal layer comprises aluminum, gold, silver, or combinations thereof; the optically-transparent material comprises glass, borosilicate, SiO₂, a polymer, or combinations thereof; or combinations thereof.

Clause B1. A luminescence detection system, comprising:
a device comprising:
   a first layer comprising an optically-transparent material, the first layer having a first surface and a second surface opposite the first surface;
   a second layer comprising:
      a well comprising:
         an opening, the opening formed in the second layer and facing the first surface of the first layer;
         a bottom wall disposed opposite the opening; and
         a sidewall extending between the opening and the bottom wall, the sidewall having a first region extending from the opening and a second region extending from the first region to the bottom wall, the first region having a substantially constant or constant radius and the second region having a first radius adjacent to the first region and a second radius adjacent to the bottom wall, wherein the second radius is smaller than the first radius; and
an optically reflective metal layer disposed over at least a portion of the bottom wall and the sidewall of the well; and
a detector adapted to be optically coupled to the device.

Clause B2. The luminescence detection system of Clause B1, wherein the detector is positioned below the first surface of the first layer.

Clause B3. The luminescence detection system of any one of Clause B1 or Clause B2, wherein the detector comprises a fluorescence detector, a chemiluminescence detector, an electrochemiluminescence detector, or combinations thereof.

Clause C1. A method of detecting an analyte in a sample, the method comprising:
introducing a sample to a well of a device under conditions effective to detect an analyte present in the sample, the device further comprising:
   a first layer comprising an optically-transparent material, the first layer having a first surface and a second surface opposite the first surface;
   a second layer comprising:
      the well comprising:
         an opening, the opening formed in the second layer and facing the first surface of the first layer;
         a bottom wall disposed opposite the opening; and
         a sidewall extending between the opening and the bottom wall, the sidewall having a first region extending from the opening and a second region extending from the first region to the bottom wall, the first region having a substantially constant or constant radius and the second region having a first radius adjacent to the first region and a second radius adjacent to the bottom wall, wherein the second radius is smaller than the first radius; and
   an optically reflective metal layer disposed over at least a portion of the bottom wall and the sidewall of the well; and detecting the presence or absence of the analyte in the well with a detector.

Clause C2. The method of Clause C1, wherein:
the second region of the well comprises a focal point positioned along a vertical axis of the well and between a center of the bottom wall and a volumetric center of the well; and
the detecting the presence or absence of an analyte comprises focusing the detector onto the focal point.

Clause C3. The method of Clause C2:
wherein the detecting the presence or absence of an analyte comprises detecting light that is indicative of the presence of the analyte; and
wherein the detecting the light comprises detecting the light by absorbance, reflectance, or fluorescence, or combinations thereof.

Clause C4. The method of any one of Clauses C1-C3, wherein the introducing the sample to the well of the device comprises introducing an enzyme and a substrate to the well of the device.

Clause C5. The method of any one of Clauses C1-C4, wherein the detector is a fluorescence detector.

Clause D1. A device for luminescence detection, comprising:
a first layer comprising an optically-transparent material or substantially optically-transparent material, the first layer having a first surface and a second surface opposite the first surface;
a second layer comprising:
   a plurality of wells, each well of the plurality of wells comprising:
      an opening, the opening facing the first surface of the first layer;
      a bottom wall; and
      a sidewall extending between the opening and the bottom wall; and
a metal layer disposed over at least a portion of the bottom wall and the sidewall of the first well.

Clause D2. The device of Clause D1, wherein the first well of the plurality of wells has a volume that is from about 500 nL to about 100 μL; and the volume corresponds to a diameter (or width) in one dimension of the opening, a diameter (or width) in one dimension of the bottom wall, and a depth measured from an opening surface to the bottom wall.

Clause D3. The device of Clause D2, wherein the volume of the first well is from about 1 μL to about 20 μL.

Clause D4. The device of any one of Clauses D1-D3, wherein the first well of the plurality of wells comprises: an opening having a diameter of about 1,000 μm or less; a depth from an opening surface to the bottom wall that is about 200 μm or less; or combinations thereof.

Clause D5. The device of Clause D4, wherein the diameter of the opening is from about 20 μm to about 60 μm; the depth from the opening surface to the bottom wall is from about 15 μm to about 45 μm; or; combinations thereof.

Clause D6. The device of any one of Clauses D1-D5, further comprising a channel in fluid communication with the first well and a second well of the plurality of wells.

Clause D7. The device of any one of Clauses D1-D6, wherein the metal layer has a thickness that is from about 50 nm to about 150 nm.

Clause D8. The device of any one of Clauses D1-D7, wherein the metal layer is optically reflective.

Clause D9. The device of any one of Clauses D1-D8, wherein the metal layer comprises aluminum, gold, silver, or combinations thereof.

Clause D10. The device of any one of Clauses D1-D9, wherein the metal layer comprises aluminum.

Clause D11. The device of any one of Clauses D1-D10, wherein the optically-transparent material or substantially optically-transparent material comprises glass, borosilicate, SiO₂, a polymer, or combinations thereof.

Clause D12. The device of any one of Clauses D1-D11, wherein the bottom wall is concave or planar.

Clause D13. The device of any one of Clauses D1-D12, wherein the bottom wall is concave.

Clause E1. A luminescence detection system, comprising:
a microfluidic device comprising:
   a first layer comprising an optically-transparent material or substantially optically-transparent material, the first layer having a first surface and a second surface opposite the first surface;
   a second layer comprising:
      a plurality of wells, each well of the plurality of wells comprising:
      an opening, the opening facing the first surface of the first layer;
      a bottom wall; and
      a sidewall extending between the opening and the bottom wall; and
   an optically reflective metal layer disposed over at least a portion of the bottom wall and the sidewall of the first well; and
a detector optically coupled to the microfluidic device.

Clause E2. The luminescence detection system of Clause E1, wherein the detector is positioned below the first surface of the first layer.

Clause E3. The luminescence detection system of any one of Clause E1 or Clause E2, wherein the detector comprises a fluorescence detector, a chemiluminescence detector, an electrochemiluminescence detector, or combinations thereof.

Clause E4. The luminescence detection system of any one of Clauses E1-E3, wherein: the metal layer comprises aluminum, gold, silver, or combinations thereof; the optically-transparent material or substantially optically-transparent material of the first layer comprises glass, borosilicate, SiO₂, a polymer, or combinations thereof, or combinations thereof.

Clause F1. A method of luminescence detection, comprising:
positioning a device described herein above a luminescence detector such that the first layer of the device is nearer the detector, the well of the device having a sample disposed therein, the sample containing an analyte; and
detecting or measuring a luminescent signal emanating from the well and the analyte.

Clause G1. A method of detecting an analyte in a sample, the method comprising:
introducing a reagent and a sample to a well of a device, under conditions effective to detect the analyte, the device further comprising:
   a first layer comprising an optically-transparent material or substantially optically-transparent material, the first layer having a first surface and a second surface opposite the first surface; and
   a second layer comprising:
      the well comprising:
         an opening, the opening facing the first surface of the first layer;
         a bottom wall; and
         a sidewall extending between the opening and the bottom wall; and
   a metal layer disposed over at least a portion of the bottom wall and the sidewall of the well; and
detecting the presence or absence of the analyte in the well with a detector.

Clause G2. The method of Clause G1, wherein the detecting the presence or absence of an analyte comprises detecting light that is indicative of the presence of the analyte.

Clause G3. The method of Clause G2, wherein the detecting light comprises detecting light by absorbance, reflectance, or fluorescence, or combinations thereof.

Clause G4. The method of any one of Clauses G1-G3, wherein the conditions effective to detect an analyte comprises an enzyme and a substrate.

Clause G5. The method of any one of Clauses G1-G4, wherein the detector is a fluorescence detector.

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications may be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method, or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

In the foregoing, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the foregoing aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, embodiments comprising “a layer” include embodiments comprising one, two, or more layers, unless specified to the contrary or the context clearly indicates only one layer is included.

While the foregoing is directed to embodiments of the present disclosure, other and further embodiments of the disclosure may be devised without departing from the basic scope thereof, and the scope thereof is determined by the claims that follow.

What is claimed is:

1. A device for luminescence detection, comprising:
a first layer comprising an optically-transparent material, the first layer having a first surface and a second surface opposite the first surface;
a second layer comprising:
a well comprising:
an opening, the opening formed in the second layer and facing the first surface of the first layer;
a bottom wall disposed opposite the opening; and
a sidewall extending between the opening and the bottom wall, the sidewall having a first region extending from the opening and a second region extending from the first region to the bottom wall, the first region having a substantially constant or constant radius and the second region having a first radius adjacent to the first region and a second radius adjacent to the bottom wall, wherein the second radius is smaller than the first radius; and
an optically reflective metal layer disposed over at least a portion of the bottom wall and the sidewall of the well.

2. The device of claim 1, wherein the radius of the second region decreases at a uniform rate from the first radius of the second region to the second radius of the second region.

3. The device of claim 1, wherein the radius of the second region decreases at a non-uniform rate from the first radius of the second region to the second radius of the second region.

4. The device of claim 1, wherein the bottom wall is curved or flat.

5. The device of claim 1, wherein the second region comprises a focal point positioned along a vertical axis of the well and between a center of the bottom wall and a volumetric center of the well.

6. The device of claim 1, wherein the well comprises:
a first radius of curvature extending from a volumetric center of the well to the sidewall; and
a second radius of curvature extending from the volumetric center of the well to the bottom wall of the well, the second radius of curvature perpendicular to the first radius of curvature.

7. The device of claim 1, wherein:
the well has a volume that is from about 500 nL to about 100 μL, the volume defined by a diameter (or width) in one dimension of the opening, a diameter (or width) in one dimension of the bottom wall, and a depth measured from an opening surface to the bottom wall.

8. The device of claim 7, wherein the volume of the well is from about 1 μL to about 30 μL.

9. The device of claim 1, wherein:
the opening of the well has a diameter (or width) of about 8 mm;
a depth of the well from the opening to the bottom wall that is about 4 mm or less; or
combinations thereof.

10. The device of claim 9, wherein:
the diameter of the opening is from about 160 μm to about 440 μm;
the depth is from about 80 μm to about 220 μm; or
combinations thereof.

11. The device of claim 1, wherein the optically reflective metal layer has a thickness that is from about 50 nm to about 150 nm.

12. The device of claim 1, wherein:
the optically reflective metal layer comprises aluminum, gold, silver, or combinations thereof;
the optically-transparent material comprises glass, borosilicate, SiO₂, a polymer, or combinations thereof; or
combinations thereof.

13. A luminescence detection system, comprising:
a device comprising:
a first layer comprising an optically-transparent material, the first layer having a first surface and a second surface opposite the first surface;
a second layer comprising:
a well comprising:
an opening, the opening formed in the second layer and facing the first surface of the first layer;
a bottom wall disposed opposite the opening; and
a sidewall extending between the opening and the bottom wall, the sidewall having a first region extending from the opening and a second region extending from the first region to the bottom wall, the first region having a substantially constant or constant radius and the second region having a first radius adjacent to the first region and a second radius adjacent to the bottom wall, wherein the second radius is smaller than the first radius; and
an optically reflective metal layer disposed over at least a portion of the bottom wall and the sidewall of the well; and
a detector adapted to be optically coupled to the device.

14. The luminescence detection system of claim 13, wherein the detector is positioned below the first surface of the first layer.

15. The luminescence detection system of claim 13, wherein the detector comprises a fluorescence detector, a chemiluminescence detector, an electrochemiluminescence detector, or combinations thereof.

16. A method of detecting an analyte in a sample, the method comprising:
introducing a sample to a well of a device under conditions effective to detect an analyte present in the sample, the device further comprising:
a first layer comprising an optically-transparent material, the first layer having a first surface and a second surface opposite the first surface;
a second layer comprising:
the well comprising:
an opening, the opening formed in the second layer and facing the first surface of the first layer;
a bottom wall disposed opposite the opening; and
a sidewall extending between the opening and the bottom wall, the sidewall having a first region extending from the opening and a second region extending from the first region to the bottom wall, the first region having a substantially constant or constant radius and the second region having a first radius adjacent to the first region and a second radius adjacent to the bottom wall, wherein the second radius is smaller than the first radius; and
an optically reflective metal layer disposed over at least a portion of the bottom wall and the sidewall of the well; and
detecting the presence or absence of the analyte in the well with a detector.

17. The method of claim 16, wherein:
the second region of the well comprises a focal point positioned along a vertical axis of the well and between a center of the bottom wall and a volumetric center of the well; and
the detecting the presence or absence of an analyte comprises focusing the detector onto the focal point.

18. The method of claim 17:
wherein the detecting the presence or absence of an analyte comprises detecting light that is indicative of the presence of the analyte; and
wherein the detecting the light comprises detecting the light by absorbance, reflectance, or fluorescence, or combinations thereof.

19. The method of claim 16, wherein the introducing the sample to the well of the device comprises introducing an enzyme and a substrate to the well of the device.

20. The method of claim 16, wherein the detector is a fluorescence detector.
